(19) United States
(12) Patent Application Publication
(10) Pub. No.: US 2009/0310086 A1
(43) Pub. Date: Dec. 17, 2009

(54) Light projector and projection method with enhanced contrast

(76) Inventor: Haizhang Li, Orlando, FL (US)

Correspondence Address: RONALD J. MEETIN, ATTORNEY AT LAW, 210 CENTRAL AVENUE, MOUNTAIN VIEW, CA, 94043-4869, US

(21) Appl. No.: 12/214,184

(22) Filed: Jun. 16, 2008

(51) Int. Cl. G03B 21/14; G02F 1/1335

(52) U.S. Cl. 353/20; 353/31; 349/5

(57) ABSTRACT

A light projector contains a plurality of optical assemblies (100, 102, and 104 or 200; 300, 302, and 304 or 380; 500, 504, and 502, 560, 600, 640, or 680) for respectively modulating light of a like plurality of primary beams (110, 114, and 118 or 202; 310, 314, and 318 or 382; not shown, not shown, and 514, 562, 602, 642, or 682) of linearly polarized light to respectively produce a like plurality of further beams (112, 116, and 120 or 204; 312, 316, and 320 or 384; 512, 520, and 516, 564, 604, 644, or 684) of modulated light. At least one, but not all, of the optical assemblies sequentially modulates light of its primary beam so as to enhance the contrast. A beam combiner combines (106) light of the further beams to produce a composite beam of light. A projection lens device (108) projects light of the composite beam.

### FIELD OF USE

This invention relates to light projection and, in particular, to light projection using linearly polarized light.

### BACKGROUND ART

FIG. 1 illustrates a conventional color light projector as described, for example in various references such as Cobb et al. U.S. Pat. No. 6,758,565 B1. The conventional projector of FIG. 1 consists of three optical assemblies 20_{X}, 20_{Y}, and 20_{Z}, X-cube beam combiner 22, and projection lens device 24 that projects a polychromatic image on display screen 26. Optical assemblies 20_{X}-20_{Z} provide light of three different colors, normally red, blue, and green, modulated in accordance with the displayed image.

Each optical assembly 20ᵢ is formed with color light source 30ᵢ, polarization beam splitter (“PBS”) 32ᵢ, and reflective light modulator 34ᵢ where i is a letter that runs from X to Z. Each light source 30ᵢ provides a beam of linearly (or plane) polarized light 40ᵢ of a different one of the three colors. Light sources 30_{X}-30_{Z} may include a general light source (not shown) which provides unpolarized light that is suitably processed to produce linearly polarized color beams 40_{X}-40_{Z}.

Linearly polarized color beams 40_{X}-40_{Z} are of the s linear polarization type. In this regard, light is characterized by an electric field having an electric-field vector. A light ray generally consists of two orthogonal linearly polarized components commonly referred to as the s and p components. When a light ray is illustrated in a drawing, the p linearly polarized component normally has its electric-field vector parallel to the plane of the drawing. The s linearly polarized component then has its electric-field vector perpendicular to the drawing's plane.

Light of each s linearly polarized color beam 40ᵢ reflects off PBS 32ᵢ. Modulator 34ᵢ modulates the reflected light and selectively reflects part of it back as p linearly polarized color beam 42ᵢ that passes through PBS 32i. X-cube combiner 22 combines p linearly polarized color beams 42X-42Z to produce polychromatic, specifically trichromatic, composite color light beam 44. Projection lens device 24 then projects composite beam 44 on screen 26 to produce the displayed image.

The contrast ratio of a light modulator is basically the ratio of the maximum intensity of modulated light provided by the modulator to the minimum intensity of light modulated by the modulator. This is sometimes described as the ratio of the intensity of the lightest picture element (pixel) in the modulator to the intensity of the darkest pixel in the modulator. The contrast ratio for a light modulator of the liquid-crystal display type is normally less than 1,000.

Many display applications, such as night-vision simulation, require high contrast ratio well in excess of 1,000. For instance, a contrast ratio of at least 40,000 is often desirable. One way of achieving high contrast ratio and enhancing dynamic range is to use sequential modulation. U.S. Pat. Nos. 5,978,142 and 7,002,533 B1 describe sequential modulation techniques in which light is modulated by selective transmission of the light through a pair of transmissive light modulators. The resultant contrast ratio is the product of the contrast ratios of the two transmissive modulators.

FIG. 2 illustrates an image display apparatus that utilizes another known way of doing sequential light modulation as described in Bridgwater et al. (“Bridgwater”), U.S. Pat. No. 6,985,272 B2. The sequential modulation technique of FIG. 2 is performed with color polarization selector plates 50, 52, 54, and 56, optical-path compensation plate 58, PBSs 60, 62, and 64, green light modulator 66, blue light modulator 68, red light modulator 70, color cube combiner 72, relay lens 74, fourth PBS 76, and composite light modulator 78. Modulators 66, 68, 70, and 78 are all of the liquid-crystal-on-silicon (“LCoS”) reflective modulation type.

Color polarization selector 50 and PBS 60 convert incident linearly polarized white light 80 into transmitted p linearly polarized green light 82 and reflected s linearly polarized magenta light 84. After passing through PBS 60, green light 82 passes through PBS 62 and is reflectively modulated by modulator 66 to produce initially modulated s linearly polarized green light 86 that reflects off PBS 62 toward color cube combiner 72. At the same time, color polarization selector 52 and PBS 64 convert magenta light 84 into transmitted p linearly polarized blue light and reflected s linearly polarized red light. Subsequent to passage through PBS 64, the blue light is reflectively modulated by modulator 68 to produce initially modulated s linearly polarized blue light 88 that reflects off PBS 64 toward color combiner 72. After being reflected by PBS 64, the red light is reflectively modulated by modulator 70 to produce initially modulated p linearly polarized red light 90 that passes through PBS 64 toward color combiner 72.

Color polarization selectors 54 and 56 and color combiner 72 combine green light 86, blue light 88, and red light 90 to form initially modulated p linearly polarized composite light 92. Relay lens 74 relays (projects) initially modulated composite light onto PBS 76. Initially modulated composite light 92 passes through PBS 76 and is reflectively modulated by fourth modulator 78 to produce further modulated s linearly polarized composite light 94 which reflects off PBS 94 to produce an image suitable for projection on a screen.

Bridgwater asserts that use of the four-modulator technique to enhance dynamic range is advantageous because the total number of light modulators is less than the number (six) required if two modulators were used for each of the colors red, blue, and green. However, it is generally difficult to design fourth modulator 78 so as to meet the modulation needs of all three colors. In general, the contrast ratio of the four-modulator system of FIG. 2 is likely to be less than that of a six-modulator system in which two modulators are used for each of the three colors. Also, the four-modulator system of FIG. 2 is very susceptible to color-related abrasions of relay lens 74 utilized in relaying initially modulated composite light 92 onto fourth modulator 78.

Furthermore, the modulation requirements on fourth modulator 78 are severe due to the necessity to deal simultaneously with light of all three colors. In some situations, enhancing the contrast of light of one color may result in a reduction of the contrast for light of another color. It would be desirable to have a technique for achieving high contrast ratio and enhanced dynamic range in modulating multiple types of light with a low number of modulators while avoiding the problems of the four-modulator technique of FIG. 2.

### GENERAL DISCLOSURE OF THE INVENTION

The present invention furnishes such a light modulation technique. In a first aspect of the invention, a light projector contains a plurality of optical assemblies for respectively modulating light of a like plurality of primary beams of linearly polarized light to respectively produce a like plurality of further beams of modulated light. At least one, but not all, of the optical assemblies sequentially modulates light of its primary beam. A beam combiner combines light of the further beams to produce a composite beam of light. A projection lens device projects light of the composite beam.

There are color-projections situations in which high contrast ratio is needed for light of at least one color but not for light of all colors. The projector in the first aspect of this invention accommodates such situations by using sequential light modulation for light that needs high contrast ratio but not using sequential modulation for light that does not require high contrast ratio. As a result, the number of light modulators is essentially a minimum, thereby reducing the projector cost.

Importantly, each optical assembly that sequentially modulates light of its primary beam preferably does the sequential modulation substantially independently of any other optical assembly that sequentially modulates light of its primary beam. For example, if two of three optical assemblies sequentially modulate light of their primary beams, each of these two assemblies performs the sequential modulation substantially independent of the other of the two assemblies and thus uses different light modulators than the other of the two assemblies. The design of a particular implementation of the projector in the first aspect of the invention is facilitated because, unlike what occurs in Bridgwater, it is not necessary for the components used in sequential light modulation to meet the needs of light of multiple colors. Consequently, the performance of the projector in the invention's first aspect is considerably enhanced.

Each sequentially modulating optical assembly normally contains a source of the primary beam of that optical assembly, a first modulator for modulating light of the primary beam of that optical assembly to produce an intermediate beam of light, and a second modulator for modulating light of the intermediate beam to produce light constituting the further beam of that optical assembly. Light-directing structure variously directs light to, between, and away from the source and the first and second modulators. Each modulator is, for example, implemented with a liquid-crystal display. The second modulator preferably operates in a reflective manner. The first modulator may then operate in a reflective or transmissive manner.

A light projector in a second aspect of the invention contains three optical assemblies that respectively sequentially modulate light of three primary beams of linearly polarized light to respectively produce three further beams of modulated light. An X-cube beam combiner combines light of the further beams to produce a composite beam of light. A projection lens device projects light of the composite beam.

X-cube beam combiners operate in a highly efficient manner and are readily commercially available. As a result, the light projector in the second aspect of the invention normally performs very well.

An optical assembly in each of four additional aspects of the invention contains a light source, first and second light modulators, and a polarization beam splitter (again “PBS”) or a pair of PBSs. The light source provides a primary beam of linearly polarized light of a first linear polarization type. Both modulators operate in a reflective manner.

More particularly, the optical assembly in the third aspect of the invention contains a single PBS that reflects light of the primary beam to produce a reflected beam of linearly polarized light of the first linear polarization type. The first modulator reflectively modulates light of the reflected beam to produce an initial modulated beam of linearly polarized light of a second linear polarization type opposite to the first linear polarization type.

Light of the initial modulated beam is transmitted through the PBS to produce a first intermediate modulated beam of linearly polarized light of the second linear polarization type. The second modulator reflectively modulates light of the first intermediate modulated beam to produce a second intermediate modulated beam of linearly polarized light of the first linear polarization type. Light of the second intermediate modulated beam is reflected by the PBS to produce a further modulated beam of linearly polarized light of the first linear polarization type.

The optical assembly in the fourth aspect of the invention similarly contains a single PBS and is configured to operate generally in a complementary manner to the optical assembly in the third aspect of the invention. In the optical assembly of the fourth aspect of the invention, the PBS transmits light of the primary beam to produce a transmitted beam of linearly polarized light of the first linear polarization type. The first modulator reflectively modulates light of the transmitted beam to produce an initial modulated beam of linearly polarized light of the second linear polarization type. Light of the initial modulated beam is reflected by the PBS to produce a first intermediate modulated beam of linearly polarized light of the second linear polarization type.

The second modulator reflectively modulates light of the first intermediate modulated beam to produce a second intermediate modulated beam of linearly polarized light of the first linear polarization type. Light of the second intermediate modulated beam is transmitted by the PBS to produce a further modulated beam of linearly polarized light of the first linear polarization type. The optical assemblies in the third and fourth aspects of the invention are advantageous because each of them requires only a single PBS.

The optical assembly in the fifth aspect of the invention contains first and second PBSs. The primary beam is formed with light of a selected color. The first PBS reflects light of the primary beam to produce a reflected beam of linearly polarized light of the first linear polarization type. The first modulator reflectively modulates light of the reflected beam to produce an initial modulated beam of linearly polarized light of the second linear polarization type. Light of the initial modulated beam is transmitted by the first PBS to produce a first intermediate modulated beam of linearly polarized light of the second linear polarization type;

The second PBS substantially solely transmits light of the first intermediate beam to produce a second intermediate beam of linearly polarized light of the second linear polarization type. The second modulator substantially solely reflectively modulates light of the second intermediate modulated beam to produce a third intermediate modulated beam of linearly polarized light of the first linear polarization type. Light of the third intermediate modulated beam is reflected by the second PBS to produce a further modulated beam of linearly polarized light of the first linear polarization type.

The optical assembly in the sixth aspect of the invention likewise contains first and second PBSs and is configured to operate generally in a complementary manner to the optical assembly in the fifth aspect of the invention. In the optical assembly of the sixth aspect of the invention, the first PBS transmits light of the primary beam to produce a transmitted beam of linearly polarized light of the first linear polarization type. The first modulator reflectively modulates light of the transmitted beam to produce an initial modulated beam of linearly polarized light of the second linear polarization type. Light of the initial modulated beam is reflected by the first PBS to produce a first intermediate modulated beam of linearly polarized light of the second linear polarization type.

The second PBS reflects light of the first intermediate beam to produce a second intermediate beam of linearly polarized light of the second linear polarization type. The second modulator reflectively modulates light of the second intermediate modulated beam to produce a third intermediate modulated beam of linearly polarized light of the first linear polarization type. Light of the third intermediate modulated beam is transmitted by the second PBS to produce a further modulated beam of linearly polarized light of the first linear polarization type.

An optical assembly in each of two further aspects of the invention contains a light source, first and second light modulators, and a PBS. The light source provides a primary beam of linearly polarized light of the first or second linear polarization type. The first light modulator operates in a transmissive manner rather than in a reflective manner as in the preceding four aspects of the invention. The second light modulator again operates in a reflective manner. As with the optical assemblies in the third and fourth aspects of the invention, the optical assemblies in these seventh and eights aspects of the invention are advantageous because each of them requires only a single PBS.

In the seventh aspect of the invention, the first modulator transmissively modulates light of the primary beam to produce an initial modulated beam of linearly polarized light of the second linear polarization type. The PBS reflects light of the initial modulated beam to produce a first intermediate beam of linearly polarized light of the second linear polarization type. The second modulator reflectively modulates light of the first intermediate modulated beam to produce a second intermediate modulated beam of linearly polarized light of the first linear polarization type. Light of the second intermediate modulated beam is transmitted through the PBS to produce a further modulated beam of linearly polarized light of the first linear polarization type.

The first modulator in the eighth aspect of the invention transmissively modulates light of the primary beam to produce an initial modulated beam of linearly polarized light of the first linear polarization type. The PBS transmits light of the initial modulated beam to produce a first intermediate beam of linearly polarized light of the first linear polarization type. The second modulator reflectively modulates light of the first intermediate modulated beam to produce a second intermediate modulated beam of linearly polarized light of the second linear polarization type. Light of the second intermediate modulated beam is reflected by the PBS to produce a further modulated beam of linearly polarized light of the second linear polarization type.

The optical assemblies of the present invention are especially suitable for use in providing sequential light modulation in the light projectors of the first and second aspects of the invention. Because all light modulation is performed before any light beams are combined, the optical path of each fully modulated light beam can be modified to meet application needs largely independent of the optical path of each other fully modulated light beam. This greatly reduces development cost and time.

In short, the light projector in the first aspect of the inventions typically provides high contrast ratio only for light that needs high contrast ratio. This enables the component count, and attendant cost, to be kept low. Design difficulties arising from attempting to tailor a component to meet the needs of light of different colors are substantially avoided in the light projector of the invention's first aspect. The invention thus provides a substantial advance over the prior art.

### BRIEF DESCRIPTION OF THE DRAWINGS

FIGS. 1 and 2 cross-sectional top views of two conventional color light projectors.

FIGS. 3-14 are cross-structural top views of ten color light projectors configured according to the invention.

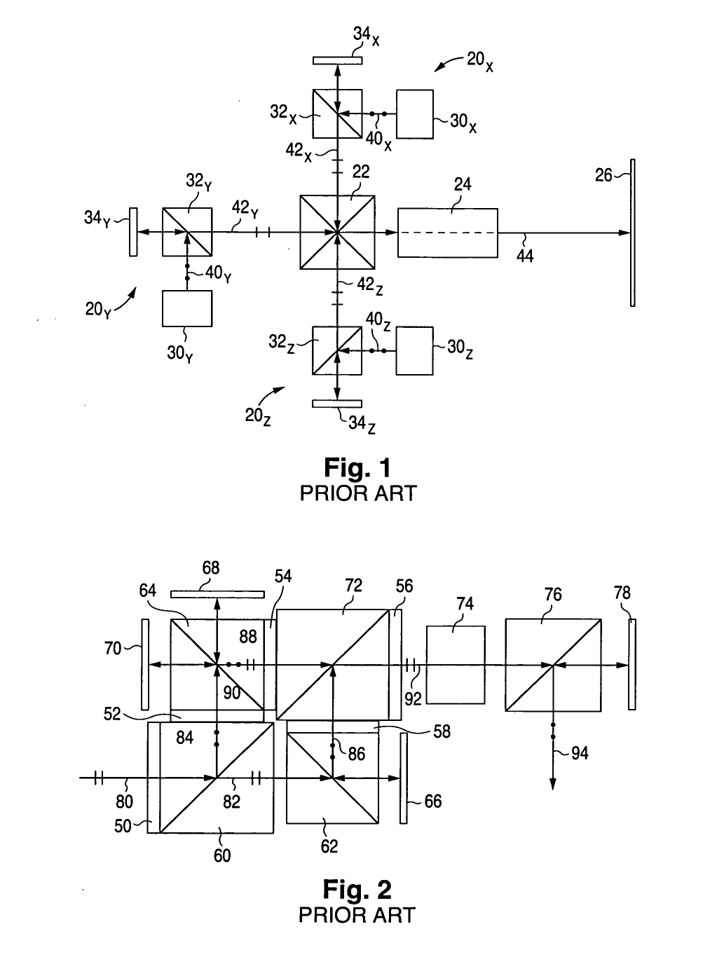

Like reference symbols are used in the drawings and in the description of the preferred embodiments to represent the same, or very similar, item or items.

Beams of linearly polarized light whose electric-field vectors point, or whose direction of polarization is, parallel to the plane of a drawing are indicated by lines having short crossing lines. Beams of linearly polarized light whose electric-field vectors point, or whose direction of polarization is, perpendicular to the plane of a drawing are indicated by lines having dots. Beams of non-linearly polarized light shown on a drawing having beams of linearly polarized light are indicated by lines having both dots and short crossing lines.

In instances where a beam of reflected light travels substantially parallel to the same optical axis as the beam of incident light, the beam of reflected light is often represented by a line laterally separated from, but parallel to, the line representing the beam of incident light in order to distinguish the two light beams.

### DESCRIPTION OF THE PREFERRED EMBODIMENTS

### Preliminary Matters

The source of linearly polarized light in each optical assembly in each light projector configured according to the invention can be implemented with any of the inventive polarization-recovery illumination systems disclosed in Vidal et al., co-filed U.S. patent application Ser. No. ______, attorney docket no. R-0011 US, the contents of which are incorporated by reference herein. All of the light beams processed by each optical assembly in each of the present light projectors are of the same color as that assembly's modulated output beam.

All of the light modulators used in the optical assemblies of the present light projectors preferably are liquid-crystal displays (“LCDs”). The reflective LCDs may employ LCoS technology. Each modulator includes suitable modulator control circuitry.

There instances in which a pair of optical assemblies formed with corresponding components that operate in the same way are shown in the drawing of a light projector containing those optical assemblies as being mirror images of each other. This difference, even if it exists in a physical embodiment of any of the present projectors, is generally immaterial to the projector's operation. In fact, the difference can be eliminated by simply turning one of the projector's optical assemblies upside down. Accordingly, any two optical assemblies formed with corresponding components that operate in the same way in a light projector configured according to the invention and containing those optical assemblies are considered to be identically configured even if the optical assemblies are pictorially depicted as mirror images of each other.

Except as otherwise indicated, all light reflections described below are by approximately 180°, i.e., the reflected light beam travels along largely the same optical path as the incident light beam but in the opposite direction. In particular, the modulated light beam generated by reflecting selectively reflecting parts of the light beam incident on each reflective light modulator travels in largely the opposite direction as the incident beam. The same applies to a light reflector used with a quarter-wave retardation plate.

Each optical assembly in each of the present light projectors has an output optical axis along which color light of that assembly's modulated output light beam travels to a pair of intersecting X-cube beam-combiner dichroic mirrors. Although not separately demarcated in the drawings illustrating the projectors of the invention, the output axes of their optical assemblies are respectively coincident with the drawing lines that respectively represent the modulated output light beams of those optical assemblies. The output optical axis of each optical assembly in each of the present projectors is at approximately a 45° angle to each dichroic mirror.

When light of the modulated output beam of an optical assembly in one of the present projectors is reflected by one of the X-cube beam-combiner dichroic mirrors and transmitted by the other dichroic mirror, some rays of the modulated assembly output light beam are reflected by the first mirror and subsequently transmitted by the second mirror while other rays of the modulated assembly output light beam are transmitted by the second mirror and subsequently reflected by the first mirror. In such situations, the modulated assembly output beam is simply described below as being reflected by the first mirror and transmitted by the second mirror without reference to the order of reflection and transmission for different parts of the beam.

A linearly polarized polychromatic color beam created by combining light of linearly polarized monochromatic color beams generated by a plurality of numbered optical assemblies so as to be of mixed p and s linear polarization types is sometimes described herein as being of “xx . . . x” mixed linear polarization where each “x” is p or s. In each such instance, the first p or s refers to the linear polarization type of the light beam provided by the first-numbered optical assembly, the second p or s refers to the linear polarization type of the light beam provided by the second-numbered optical assembly, and so on.

### Light Projectors Configured According to Invention

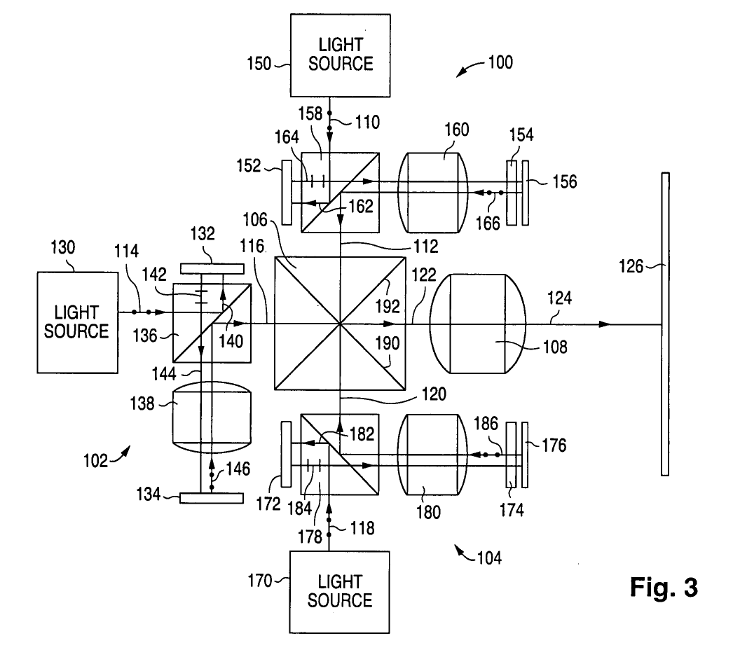

FIG. 3 illustrates an LCD polychromatic, specifically trichromatic, color light projector configured in accordance with the invention so as to employ fully reflective sequential modulation on light of one of three colors and to employ single modulation on light of each of the other two colors. The three colors preferably are red, green, and blue. The light projector of FIG. 3 consists of a single-modulating first optical assembly 100, a double-modulating second optical assembly 102, a single-modulating third optical assembly 104, an X-cube beam combiner 106, and a projection lens device 108.

Single-modulating optical assembly 100 singly modulates a monochromatic primary beam 110 of linearly polarized light of a selected one of the three colors to produce a modulated monochromatic further beam 112 of linearly polarized light of the selected color. Double-modulating optical assembly 102 sequentially doubly modulates a monochromatic primary beam 114 of linearly polarized light of a second selected one of the three colors in a fully reflective modulating manner to produce a modulated monochromatic further beam 116 of linearly polarized light of the second selected color. Single-modulating optical assembly 104 singly modulates a monochromatic primary beam 118 of linearly polarized light of the remaining one of the three colors to produce a modulated monochromatic further beam 120 of linearly polarized light of the remaining color. Modulated monochromatic light beams 112, 116, and 120 present images in the three respective colors.

The red light of one of modulated assembly output beams 112, 116, and 120 has a wavelength of 600-720 nm, preferably 610-700 nm, more preferably 620-680 nm. The green light of another of assembly output beams 112, 116, and 120 has a wavelength of 500-580 nm, preferably 505-570 nm, more preferably 510-560 nm. The blue light of the third of beams 112, 116, and 120 has a wavelength of 400-495 nm, preferably 430-490 nm, more preferably 445-485 nm.

Each color of light is normally characterized by a center wavelength λ_{c} and a spectrum width 2Δλ_{c} defined as full width at half maximum and centered on center wavelength λ_{c}. That is, the wavelength of the large majority of the rays of each color of light is λ_{c}±Δλ_{c}. Spectrum half width Δλ_{c} is normally no more than 60 nm, preferably no more than 50 nm, typically no more that 40 nm.

Center wavelength λ_{c} for the red light is normally 610-700 nm, preferably 620-680 nm, typically approximately 625 nm. Spectrum half width Δλ_{c} for the red light is typically approximately 20 nm at the typical λ_{c} value of 625 nm. Center wavelength λ_{c} for the green light is normally 505-570 nm, preferably 520-560 nm, typically approximately 530 nm. Spectrum half width Δλ_{c} for the green light is typically approximately 40 nm at the typical λ_{c} value of 528 nm. Center wavelength λ_{c} for the blue light is normally 430-490 nm, preferably 445-485 nm, typically approximately 465 nm. Spectrum half width Δλ_{c} for the blue light is typically approximately 25 nm at the typical λ_{c} value of 465 nm. The fact that the Δλ_{c} spectrum half width values for each of the three colors sometimes take the wavelength outside the maximum λ_{c} center wavelength range for that color is acceptable because the wavelengths of the large majority of light rays of that color fall within its λ_{c} center wavelength range.

White light consists of approximately 72% green light, approximately 24% red light, and 4% blue light. In view of this, the need for increased modulation of color light to improve contrast among these three colors is typically greatest for green light, second greatest for red light, and least for blue light. Modulated beam 116 of double-modulating optical assembly 102 is therefore preferably green light. Modulated beams 112 and 120 of single-modulating optical assemblies 100 and 104 are then respectively red light and blue light or vice versa.

A typical value of the contrast ratio in the images presented by singly modulated beams 112 and 120 of optical assemblies 100 and 104 is 500. The corresponding value of the contrast ratio in the image presented by sequentially doubly modulated beam 116 of optical assembly 102 is approximately 500×500 or 250,000. In the preferred case where doubly modulated beam 116 of assembly 102 consists of green light, the contrast ratio in the image presented by the green light is then approximately 250,000.

X-cube beam combiner 106 combines light of modulated beams 112, 116, and 120 to produce a composite beam 122 of linearly polarized trichromatic color light that travels generally along a projection optical axis 124. Composite trichromatic light beam 122 presents a composite color image of the three images presented by modulated beams 112, 116, and 120. Projection lens device 108 projects light of composite beam 122 along projection axis 124 onto a screen 126 so as to largely present the composite color image on screen 126.

The linearly polarized color light of monochromatic primary beams 110, 114, and 118 is of s linear polarization type. The linear polarized color light of modulated monochromatic beams 112, 116, and 120 is also of s linear polarization type. As a result, the linear polarized color light of composite trichromatic beam 122 is all of s linear polarization type.

Double-modulating optical assembly 102 consists of a monochromatic light source 130, a first reflective light modulator 132, a second reflective light modulator 134, and light-directing structure formed with a polarization beam splitter (once again, “PBS”) 136 and a relay lens 138. Light source 130 provides primary light beam 114 of s linearly polarized color light, preferably green light. PBS 136 reflects light of primary beam 114 by approximately 90° to produce a reflected beam 140 of s linearly polarized color light.

First modulator 132 reflectively modulates light of reflected beam 140 to produce a reflected initial modulated beam 142 of p linearly polarized color light. Since incident light beam 140 is of s linear polarization type, modulator 132 causes initial modulated light beam 142 to be of the opposite linear polarization type to incident beam 140. Light of initial modulated beam 142 is transmitted through PBS 136 to produce a first intermediate modulated beam 144 of p linearly polarized color light. Relay lens 138 directs light of first intermediate modulated beam 144 to second modulator 134.

Second modulator 134 reflectively modulates light of first intermediate modulated beam 144 to produce a reflected second intermediate modulated beam 146 of s linearly polarized color light. Second intermediate modulated beam 146 is thus fully reflectively sequentially doubly modulated. Because incident beam 144 is of p linear polarization type, modulator 134 causes second intermediate modulated light beam 146 to be of the opposite linear polarization type to incident beam 144. Relay lens 138 directs light of second intermediate modulated beam 146 to PBS 136. Light of second intermediate modulated beam 146 is then reflected by PBS 136 by approximately 90° to produce further modulated beam 116 of s linearly polarized color light as the output beam of double-modulating optical assembly 102.

Turning to single-modulating optical assembly 100, it consists of a monochromatic light source 150, a reflective light modulator 152, a quarter-wave retardation plate 154, a light reflector 156, and light-directing structure formed with a PBS 158 and a relay lens 160. Quarter-wave retardation plate 154 and light reflector 156 may be considered part of the light-directing structure of optical assembly 100 because they perform a light-direction reversal function similar to that provided by second reflective light modulator 134 in double-modulating optical assembly 102. Light source 150 here provides primary light beam 110 of s linearly polarized color light, preferably red or blue light. PBS 158 reflects light of primary beam 110 by approximately 90° to produce a reflected beam 162 of s linearly polarized color light.

Modulator 152 reflectively modulates light of reflected beam 162 to produce a reflected modulated first intermediate beam 164 of p linearly polarized color light. Since incident beam 162 is of s linear polarization type, modulator 152 causes modulated first intermediate light beam 164 to be of the opposite linear polarization type to incident beam 162. Light of modulated first intermediate beam 164 is transmitted through PBS 158 and directed by relay lens 160 to quarter-wave retardation plate 154.

Quarter-wave retardation plate 154 is attuned to the wavelength of primary light beam 110 and thus to the wavelength of modulated first intermediate light beam 164. The fast axis of retardation plate 154 is at approximately a 45° angle to the plane of polarization of first intermediate light beam 164. Retardation plate 154 converts light of first intermediate beam 164 into a second intermediate beam of circularly polarized color light of left-handed or right-handed circular polarization depending on whether the angle between the fast axis of retardation plate 154 and the plane of polarization of first intermediate light beam 164 is +45° or −45° measured clockwise in the direction of light propagation.

Light reflector 156 reflects light of the second intermediate beam to produce a reflected third intermediate beam of circularly polarized color light of the opposite circular polarization to the second intermediate light beam. Quarter-wave retardation plate 154 then converts light of the third intermediate beam into a fourth intermediate beam 166 of s linearly polarized color light. The net effect of retardation plate 154 and light reflector 156 is to reverse the direction and linear polarization type of modulated first intermediate light beam 164, analogous to how second modulator 134 in double-modulating optical assembly 102 reverses the direction and linear polarization type of first intermediate modulated light beam 144, but without retardation plate 154 and light reflector 156 performing further modulation on first intermediate beam 164.

Relay lens 160 directs light of fourth intermediate beam 166 to PBS 158. Light of fourth intermediate beam 166 is then reflected by PBS 158 by approximately 90° to produce further modulated beam 112 of s linearly polarized color light as the output beam of single-modulating optical assembly 100.

Single-modulating optical assembly 104 consists of a monochromatic light source 170, a reflective light modulator 172, a quarter-wave retardation plate 174, a light reflector 176, and light-directing structure formed with a PBS 178 and a relay lens 180. Components 170, 172, 174, 176, 178, and 180 of optical assembly 104 are respectively deployed and operated the same as components 150, 152, 154, 156, 158, and 160 of single-modulating optical assembly 100 except that assembly 104 processes light of a different color than assembly 100. In the preferred case where assembly 100 processes one of red light and blue light, assembly 104 processes the other of red light and blue light.

Reference symbols 182, 184, and 186 in FIG. 3 identify, for optical assembly 104, beams of linearly polarized light respectively the same as linearly polarized light beams 162, 164, and 166 of optical assembly 100 except for the difference in light color. As in assembly 100, quarter-wave retardation plate 174 in assembly 104 converts p linearly polarized light of first intermediate beam 184 into a second intermediate beam of circularly polarized color light of left-handed or right-handed circular polarization. After light reflector 176 reflects light of the second intermediate beam to produce a reflected third intermediate beam of circularly polarized color light of the opposite circular polarization to the second intermediate light beam, retardation plate 174 converts light of the third intermediate beam into fourth intermediate beam 186 of s linearly polarized color light.

X-cube beam combiner 106 has a pair of dichroic mirrors 190 and 192 that intersect at approximately a 90° angle. Their faces are at approximately 45° angles to projection optical axis 124. Dichroic mirror 190 reflects linearly polarized light of the wavelength provided by optical assembly 100 and transmits linearly polarized light of the wavelengths provided by optical assemblies 102 and 104. Dichroic mirror 192 reflects linearly polarized light of the wavelength provided by assembly 104 and transmits linearly polarized light of the wavelengths provided by assemblies 100 and 102.

PBS 158 of single-modulating optical assembly 100 is situated along one side of X-cube beam combiner 106. PBS 178 of single-modulating optical assembly 104 is situated along the opposite side of X-cube 106. PBS 136 of double-modulating optical assembly 102 is situated along a third side of X-cube 106. With optical assemblies 100, 102, and 104 configured in the foregoing way, the optical path from second modulator 134 of double-modulating assembly 104 to X-cube 106 is substantially equivalent to the optical path from the combination of quarter-wave retardation plate 154 or 174 and light reflector 156 or 176 of single-modulating assembly 100 or 104 to X-cube 106. Projection lens device 108 is situated along the side of X-cube 106 opposite PBS 136.

Modulated monochromatic assembly output beams 112, 116, and 120 of s linearly polarized color light enter X-cube beam combiner 106. Light of modulated beam 112 reflects off dichroic mirror 190 making approximately a 90° bend, is transmitted through dichroic mirror 192, and travels out of X-cube 106 generally along projection optical axis 124 into projection lens device 108. Light of modulated beam 120 reflects off mirror 192 making approximately a 90° bend, is transmitted through mirror 190, and travels out of X-cube 106 generally along projection axis 124 into projection lens 108. Light of modulated beam 116 is transmitted through mirrors 190 and 192 and travels out of X-cube 106 generally along axis 124 into projection lens 108. As a result, light of beams 112, 116, and 120 combines to form composite trichromatic beam 122 of s linearly polarized color light.

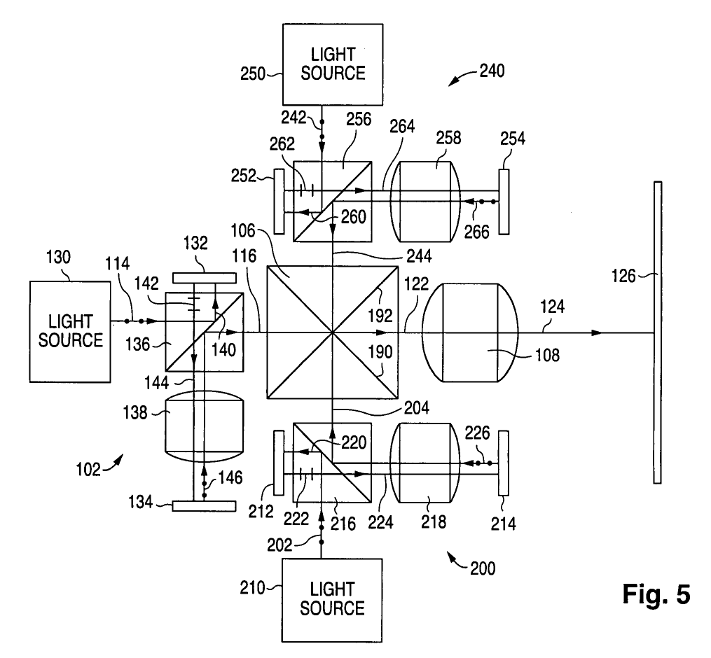

The projector of FIG. 3 is suitable for color projection applications in which high contrast ratio is needed for light of one of three colors but not for light of the other two colors. As described below in connection with FIG. 5, high contrast ratio can be achieved for all three colors by replacing single-modulating optical assemblies 100 and 104 with sequential doubly modulating configurational replicas of double-modulating optical assembly 102. In that case, two replicas of second modulator 134 in double-modulating assembly 102 respectively replace (a) the combination of quarter-wave retardation plate 154 and light reflector 156 in single-modulating assembly 100 and (b) the combination of quarter-wave retardation plate 174 and light reflector 176 in single-modulating assembly 104. However, the combination of a quarter-wave retardation plate and a light reflector is much less expensive than a reflective light modulator, including the electronic circuitry that controls the light modulation. Accordingly, the projector of FIG. 3 is economically attractive for trichromatic applications requiring high contrast ratio for light of only one color.

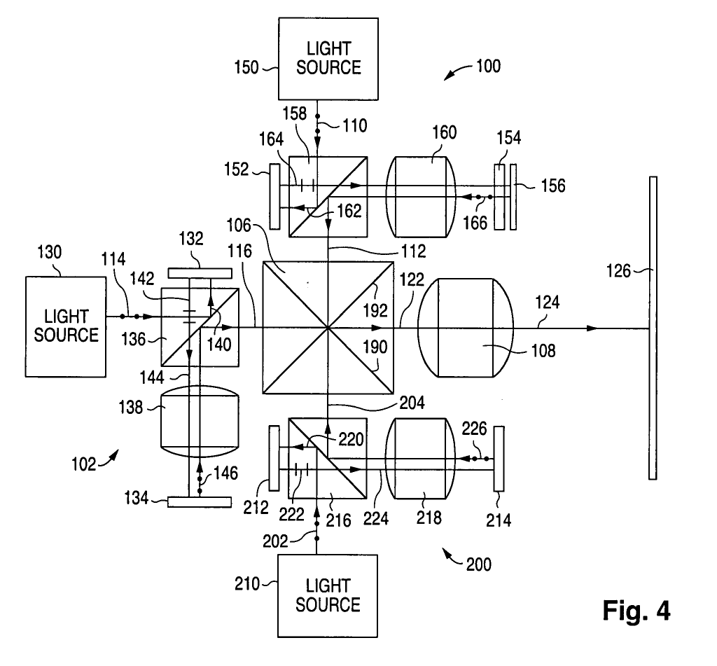

Moving to FIG. 4, it illustrates an LCD trichromatic color light projector configured in accordance with the invention so as to employ fully reflective sequential modulation on light of two of three colors and to employ single modulation on light of the third color. The three colors again preferably are red, green, and blue. The light projector of FIG. 4 consists of single-modulating first optical assembly 100, double-modulating second optical assembly 102, a double-modulating third optical assembly 200, X-cube beam combiner 106, and projection lens device 108. Single-modulating optical assembly 100, double-modulating optical assembly 102, X-cube 106, and projection lens 108 in the projector of FIG. 4 are deployed and operated the same as in the projector of FIG. 3. Double-modulating optical assembly 200 in the projector of FIG. 4 basically replaces single-modulating optical assembly 104 in the projector of FIG. 3.

Double-modulating optical assembly 200 sequentially doubly modulates a monochromatic primary beam 202 of s linearly polarized light of a selected one of the three colors in a fully reflective modulating manner to produce a modulated monochromatic further beam 204 of s linearly polarized light of the selected color. In the preferred case where the three colors are red, green, and blue, modulated beams 116 and 204 of double-modulating optical assemblies 102 and 200 are respectively green light and red light or vice versa. More particularly, modulated beam 116 of double-modulating assembly 102 is again preferably green light. Modulated beam 204 of double-modulating assembly 200 is then red light while modulated beam 112 of single-modulating optical assembly 100 is blue light.

With reference to the example presented above in connection with the projector of FIG. 3 where the value of the contrast ratio in the image presented by singly modulated beam 112 of single-modulating assembly 100 is 500, the corresponding value of the contrast ratio in the images presented by sequentially doubly modulated beams 116 and 204 of double-modulating assemblies 102 and 200 is approximately 250,000.

Double-modulating optical assembly 200 consists of a monochromatic light source 210, a first reflective light modulator 212, a second reflective light modulator 214, and light-directing structure formed with a PBS 216 and a relay lens 218. Components 210, 212, 214, 216, and 218 of optical assembly 200 are respectively deployed and operated the same as components 130,132, 134, 136, and 138 of double-modulating optical assembly 102 except that assembly 200 processes light of a different color than assembly 102. Reference symbols 220, 222, 224 and 226 in FIG. 4 identify, for assembly 200, beams of linearly polarized light respectively the same as linearly polarized light beams 140, 142, 144, and 146 of assembly 102 except for the difference in light color. Light beams 202, 222, 226, and 204 thus consist of s linearly polarized light. Light beam 224 consists of p linearly polarized light.

PBS 216 of double-modulating optical assembly 200 is situated along the side of X-cube beam combiner 106 opposite the side where PBS 158 of single-modulating optical assembly 100 is situated. Modulated monochromatic assembly output beam 204 of s linearly polarized color light enters X-cube 106. Light of modulated beam 204 reflects off dichroic mirror 192 making approximately a 90° bend, is transmitted through dichroic mirror 190, and travels out of X-cube 106 generally along projection axis 124 into projection lens device 108. Inasmuch as s linearly polarized color light of modulated monochromatic assembly output beams 112 and 116 also enters projection lens 108 along axis 124, light of beams 112, 116, and 204 combines to form composite trichromatic beam 122 of s linearly polarized color light.

Similar to what was said about the projector of FIG. 3, the projector of FIG. 4 is suitable for applications in which high contrast ratio is needed for light of two of three colors but not for light of the third color. A replica of second modulator 134 or 212 in double-modulating assembly 102 or 200 can replace the combination of quarter-wave retardation plate 154 and light reflector 156 in single-modulating assembly 100 to convert it into a sequential double-modulating high-contrast-ratio replica of double-modulating assembly as described below in connection with FIG. 5. Since the combination of a quarter-wave retardation plate and a light reflector is much less expensive than a reflective light modulator (including the light-modulation control circuitry), the projector of FIG. 3 is an economical choice for trichromatic applications requiring high contrast ratio for light of only two of the three colors.

FIG. 5 illustrates an LCD trichromatic color light projector configured in accordance with the invention so as to employ fully reflective sequential modulation on light of all three colors, once again preferably red, green, and blue. The light projector of FIG. 5 consists of a double-modulating first optical assembly 240, double-modulating second optical assembly 102, double-modulating third optical assembly 200, X-cube beam combiner 106, and projection lens device 108. Double-modulating optical assemblies 102 and 200, X-cube 106, and projection lens 108 in the projector of FIG. 5 are deployed and operated the same as in the projector of FIG. 4. Double-modulating assembly 240 in the projector of FIG. 5 basically replaces single-modulating optical assembly 100 in the projector of FIG. 4.

Double-modulating optical assembly 240 sequentially doubly modulates a monochromatic primary beam 242 of s linearly polarized light of a selected one of the three colors in a fully reflective modulating manner to produce a modulated monochromatic further beam 244 of s linearly polarized light of the selected color. Modulated monochromatic further light beam 244 presents an image in the selected color. For the preferred case in which the three colors are red, green, and blue, modulated beam 244 of optical assembly 240 is blue light when modulated further beams 116 and 204 of optical assemblies 102 and 200 are respectively green light and red light or vice versa. In any event, doubly modulated beam 116, 204, or 244 of each assembly 102, 200, or 240 is a different one of red, green, and blue light.

Optical assembly 240 consists of a monochromatic light source 250, a first reflective light modulator 252, a second reflective light modulator 254, and light-directing structure formed with a PBS 256 and a relay lens 258. Components 250, 252, 254, 256, and 258 of optical assembly 240 are respectively deployed and operated the same as components 130, 132, 134, 136, and 138 of optical assembly 102 except that assembly 240 processes light of a different color than assembly 102. Reference symbols 260, 262, 264 and 266 in FIG. 5 identify, for optical assembly 240, beams of linearly polarized light respectively the same as linearly polarized light beams 140, 142, 144, and 146 of optical assembly 102 except for the difference in light color.

PBS 256 of optical assembly 240 is situated along the side of X-cube beam combiner 106 opposite the side where PBS 216 of optical assembly 200 is situated. Modulated monochromatic assembly output beam 244 of s linearly polarized color light enters X-cube 106. Light of modulated beam 244 reflects off dichroic mirror 190 making approximately a 90° bend, is transmitted through dichroic mirror 192, and travels out of X-cube 106 generally along projection axis 124 into projection lens device 108. Since s linearly polarized color light of modulated monochromatic assembly output beams 204 and 116 also enters projection lens 108 along axis 124, light of beams 244, 116, and 204 combines to form composite trichromatic beam 122 of s linearly polarized color light.

Each of relay lenses 138, 160, 180, 218, and 258 in the inventive projectors of FIGS. 3-5 handles light of a single color rather than multiple colors as occurs with relay lens 74 in the image display apparatus of Bridgwater discussed above. As a consequence, the sensitivity of the projector of FIG. 3 to chromatic aberrations in any of lenses 138, 160, 180, 218, and 258 is less than the sensitivity of Bridgwater's image display apparatus to chromatic aberrations in its relay lens 74. Because each of relay lenses 138, 160, 180, 218, and 258 handles light of only one color, it is easier to design relay lenses 138, 160, 180, 218, and 258 to provide the requisite light-directing optics. Hence, the components of the projector of each of FIGS. 3-5 can be aligned more easily than the components of Bridgwater's display apparatus.

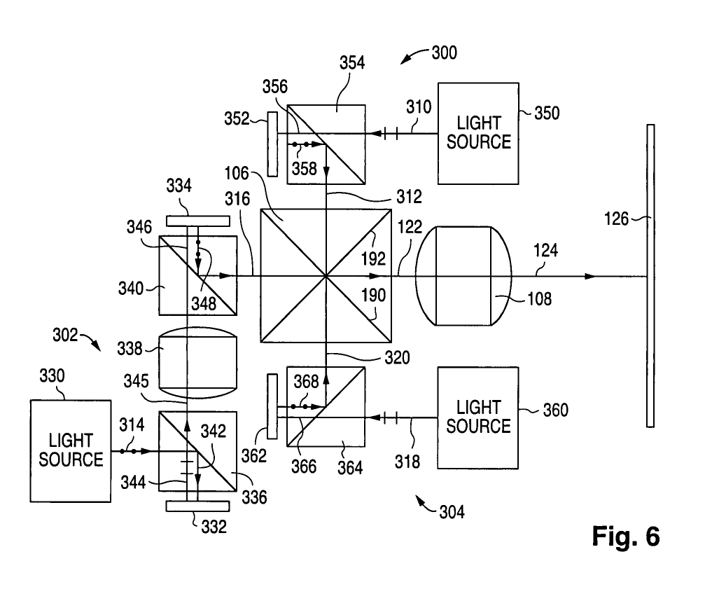

FIG. 6 illustrates another LCD trichromatic color light projector configured in accordance with the invention so as to employ fully reflective sequential modulation on light of one of three colors and to employ single modulation on light of each of the other two colors. The three colors preferably are red, green, and blue. The light projector of FIG. 6 consists of a single-modulating first optical assembly 300, a double-modulating second optical assembly 302, a single-modulating third optical assembly 304, X-cube beam combiner 106, and projection lens device 108.

Single-modulating optical assembly 300 singly modulates a monochromatic primary beam 310 of p linearly polarized light of a selected one of the three colors to produce a modulated monochromatic further beam 312 of s linearly polarized light of the selected color. Double-modulating optical assembly 302 sequentially doubly modulates a monochromatic primary beam 314 of s linearly polarized light of a second selected one of the three colors in a fully reflective modulating manner to produce a modulated monochromatic further beam 316 of s linearly polarized light of the second selected color. Single-modulating optical assembly 304 singly modulates a monochromatic primary beam 318 of p linearly polarized light of the remaining one of the three colors to produce a modulated monochromatic further beam 320 of s linearly polarized light of the remaining color.

Modulated monochromatic light beams 312, 316, and 320 present images in the three respective colors. Modulated beam 316 of double-modulating optical assembly 302 is preferably green light. Modulated beams 312 and 320 of single-modulating optical assemblies 300 and 304 are then respectively red light and blue light or vice versa. X-cube beam combiner 106 combines light of modulated beams 312, 316, and 320 to produce composite beam 122 of s linearly polarized trichromatic color light.

Double-modulating optical assembly 302 consists of a monochromatic light source 330, a first reflective light modulator 332, a second reflective light modulator 334, and light-directing structure formed with a first PBS 336, a relay lens 338, and a second PBS 340. Light source 330 provides primary light beam 314 of s linearly polarized color light, preferably green light. First PBS 336 reflects light of primary beam 314 by approximately 90° to produce a reflected beam 342 of s linearly polarized color light.

First modulator 332 reflectively modulates light of reflected beam 342 to produce a reflected initial modulated beam 344 of p linearly polarized color light. Since incident light beam 342 is of s linear polarization type, modulator 332 causes initial modulated light beam 344 to be of the opposite linear polarization type to incident beam 342. Light of initial modulated beam 344 is transmitted through PBS 336 to produce a first intermediate modulated beam 345 of p linearly polarized light. Light of first intermediate beam 345 is directed by relay lens 338 to second PBS 340 and then transmitted by PBS 340 to produce a second intermediate modulated beam 346 of p linearly polarized light.

Second modulator 334 reflectively modulates light of second intermediate modulated beam 346 to produce a reflected third intermediate modulated beam 348 of s linearly polarized color light. Third intermediate modulated light beam 348 is thereby fully reflectively sequentially doubly modulated. Because incident beam 346 is of p linear polarization type, modulator 334 causes third intermediate modulated beam 348 to be of the opposite linear polarization type to incident beam 346. Second PBS 340 then reflects light of third intermediate modulated beam 348 by approximately 90° to produce further modulated beam 316 of s linearly polarized color light as the output beam of double-modulating optical assembly 302.

Moving to single-modulating optical assembly 300, it consists of a monochromatic light source 350, a reflective light modulator 352, and light-directing structure formed with a PBS 354. Light source 350 provides primary light beam 310 of p linearly polarized color light, preferably red light or blue light. PBS 354 transmits light of primary beam 310 to produce a transmitted beam 356 of p linearly polarized color light.

Modulator 352 reflectively modulates light of transmitted beam 356 to produce a reflected modulated intermediate beam 358 of s linearly polarized color light. Since incident beam 356 is of p linear polarization type, modulator 352 causes modulated intermediate light beam 358 to be of the opposite linear polarization type to incident beam 356. Light of intermediate beam 358 is then reflected by PBS 354 by approximately 90° to produce further modulated beam 312 of s linearly polarized color light as the output beam of single-modulating optical assembly 300.

Single-modulating optical assembly 304 consists of a monochromatic light source 360, a reflective light modulator 362, and light-directing structure formed with a PBS 364. Components 360, 362, and 364 of optical assembly 304 are respectively deployed and operated the same as components 350, 352, and 354 of single-modulating optical assembly 300 except that assembly 304 processes light of a different color than assembly 300. In the preferred case where assembly 300 processes one of red light and blue light, assembly 304 processes the other of red light and blue light. Reference symbols 366 and 368 in FIG. 6 identify, for assembly 304, beams of linearly polarized light respectively the same as linearly polarized light beams 356 and 358 of assembly 300 except for the difference in light color.

PBS 354 of single-modulating optical assembly 300 is situated along one side of X-cube beam combiner 106. PBS 364 of single-modulating optical assembly 304 is situated along the opposite side of X-cube 106. Second PBS 340 of double-modulating optical assembly 302 is situated along a third side of X-cube 106. Configuration of optical assemblies 300, 302, and 304 in the preceding way enables the optical path from second modulator 334 of double-modulating assembly 304 to X-cube 106 to be substantially equivalent to the optical path from modulator 352 or 362 of single-modulating assembly 300 or 304 to X-cube 106. Projection lens device 108 is situated along the side of X-cube 106 opposite PBS 340.

Modulated monochromatic assembly output beams 312, 316, and 320 of s linearly polarized color light enter X-cube beam combiner 106. Light of modulated beam 312 reflects by approximately 90° off dichroic mirror 190, passes through dichroic mirror 192, and travels out of X-cube 106 generally along projection optical axis 124 into projection lens device 108. Light of modulated beam 320 reflects by approximately 90° off mirror 192, passes through mirror 190, and travels out of X-cube 106 generally along projection axis 124 into projection lens 108. Light of modulated beam 316 passes through mirrors 190 and 192 and travels out of X-cube 106 generally along axis 124 into projection lens 108. Light of beams 312, 316, and 320 thereby combines to form composite trichromatic beam 122 of s linearly polarized color light.

The projector of FIG. 6 is, similar to the projector of FIG. 3, suitable for color projection applications in which high contrast ratio is needed for light of one of three colors but not for light of the other two colors. The light-modulating and light-directing structure in each of single-modulating optical assemblies 300 and 304 in the projector of FIG. 6 employs a small number of components. This makes the projector of FIG. 6 economically attractive for trichromatic applications requiring high contrast ratio for light of only one color.

Two further LCD trichromatic color light projectors configured in accordance with the invention so as to employ sequential modulation on light of one of three colors and to employ single modulation on light of each of the other two colors are variations of the projectors of FIGS. 3 and 6. In one of the variations, double-modulating optical assembly 302 of the projector of FIG. 6 replaces double-modulating optical assembly 102 in the projector of FIG. 3 subject to making adjustment so that the optical path from second modulator 334 of double-modulating assembly 302 to X-cube beam combiner 106 is substantially equivalent to the optical path from the combination of quarter-wave retardation plate 154 or 174 and light reflector 156 or 176 of single-modulating optical assembly 100 or 104 to X-cube 106. In the other variation, double-modulating assembly 102 of the projector of FIG. 3 replaces double-modulating assembly 302 in the projector of FIG. 6 subject to making adjustment so that the optical path from second modulator 134 of double-modulating assembly 102 to X-cube 106 is substantially equivalent to the optical path from modulator 352 or 362 of single-modulating optical assembly 300 or 304 to X-cube 106. Optical-path adjustments can, for example, be made by variously inserting glass plates of suitable thicknesses in the optical paths.

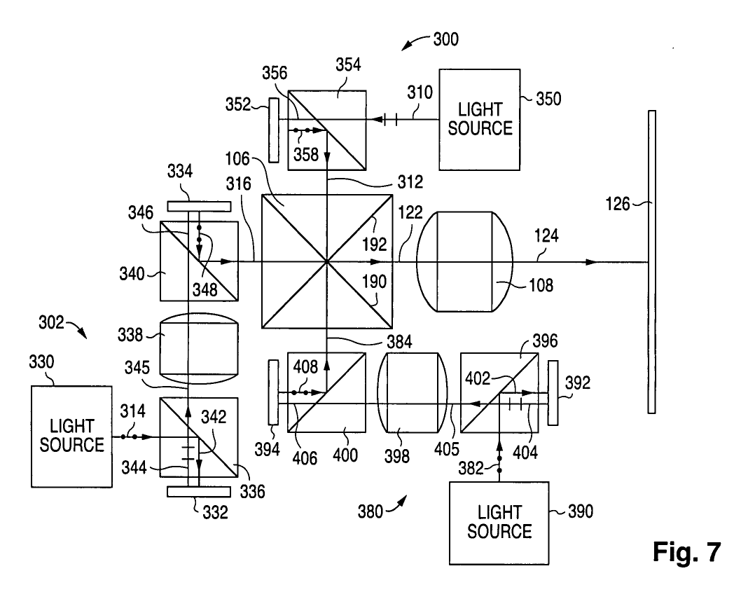

Turning to FIG. 7, it illustrates another LCD trichromatic color light projector configured in accordance with the invention so as to employ fully reflective sequential modulation on light of two of three colors and to employ single modulation on light of the third color. The three colors again preferably are red, green, and blue. The light projector of FIG. 7 consists of single-modulating first optical assembly 300, double-modulating second optical assembly 302, a double-modulating third optical assembly 380, X-cube beam combiner 106, and projection lens device 108. Single-modulating optical assembly 300, double-modulating optical assembly 302, X-cube 106, and projection lens 108 in the projector of FIG. 7 are deployed and operated the same as in the projector of FIG. 6. Double-modulating optical assembly 380 in the projector of FIG. 7 basically replaces single-modulating optical assembly 304 in the projector of FIG. 6.

Double-modulating optical assembly 380 sequentially doubly modulates a monochromatic primary beam 382 of s linearly polarized light of a selected one of the three colors in a fully reflective modulating manner to produce a modulated monochromatic further beam 384 of s linearly polarized light of the selected color. Modulated monochromatic further light beam 384 presents an image in the selected color. For the preferred case where the three colors are red, green, and blue, modulated beam 384 of double-modulating optical assembly 302 is one of green light and red light. Modulated beam 316 of double-modulating assembly 302 is the other of red light and green light. More particularly, modulated beam 316 of double-modulating assembly 302 is again preferably green light. Modulated beam 384 of double-modulating assembly 380 is then red light while modulated beam 312 of single-modulating optical assembly 300 is blue light.

Double-modulating optical assembly 380 consists of a monochromatic light source 390, a first reflective light modulator 392, a second reflective light modulator 394, and light-directing structure formed with a first PBS 396, a relay lens 398, and a second PBS 400. Components 390, 392, 394, 396, 398, and 400 of optical assembly 380 are respectively deployed and operated the same as components 330, 332, 334, 336, 338, and 340 of double-modulating optical assembly 302 except that assembly 380 processes light of a different color than assembly 302. Reference symbols 402, 404, 405, 406 and 408 in FIG. 7 identify, for optical assembly 380, beams of linearly polarized light respectively the same as linearly polarized light beams 342, 344, 345, 346, and 348 of optical assembly 302 except for the difference in light color.

Second PBS 400 of double-modulating optical assembly 380 is situated along the side of X-cube beam combiner 106 opposite the side where PBS 354 of single-modulating optical assembly 300 is situated. Modulated monochromatic assembly output beam 384 of s linearly polarized color light enters X-cube 106. Light of modulated beam 384 reflects off dichroic mirror 192 by approximately 90°, passes through dichroic mirror 190, and travels out of X-cube 106 generally along projection axis 124 into projection lens device 108. Inasmuch as s linearly polarized color light of modulated monochromatic assembly output beams 312 and 316 also enters projection lens 108 along axis 124, light of beams 312, 316, and 384 combines to form composite trichromatic beam 122 of s linearly polarized color light.

Similar to what was said about the projector of FIG. 6, the projector of FIG. 7 is suitable for applications in which high contrast ratio is needed for light of two of three colors but not for light of the third color. The light-modulating and light-directing structure in single-modulating optical assembly 300 in the projector of FIG. 7 employs a small number of components. This makes the projector of FIG. 7 an economical choice for trichromatic applications requiring high contrast ratio for light of only two of the three colors.

Two further LCD trichromatic color light projectors configured in accordance with the invention so as to employ sequential modulation on light of two of three colors and to employ single modulation on light of the third color are variations of the projectors of FIGS. 4 and 7. One of the variations is created by replacing single-modulating optical assembly 100 in the projector of FIG. 4 with single-modulating optical assembly 300 of the projector of FIG. 7 subject to making adjustment so that the optical path from modulator 352 of single-modulating assembly 300 to X-cube beam combiner 106 is substantially equivalent to the optical path from second modulator 134 or 214 of double-modulating optical assembly 102 or 200 to X-cube 106. The other variation is created by replacing single-modulating assembly 300 in the projector of FIG. 7 with single-modulating assembly 100 of the projector of FIG. 4 subject to making adjustment so that the optical path from the combination of quarter-wave retardation plate 154 and light reflector 156 of single-modulating assembly 100 is substantially equivalent to the optical path from second modulator 334 or 394 of double-modulating assembly 302 or 380 to X-cube 106.

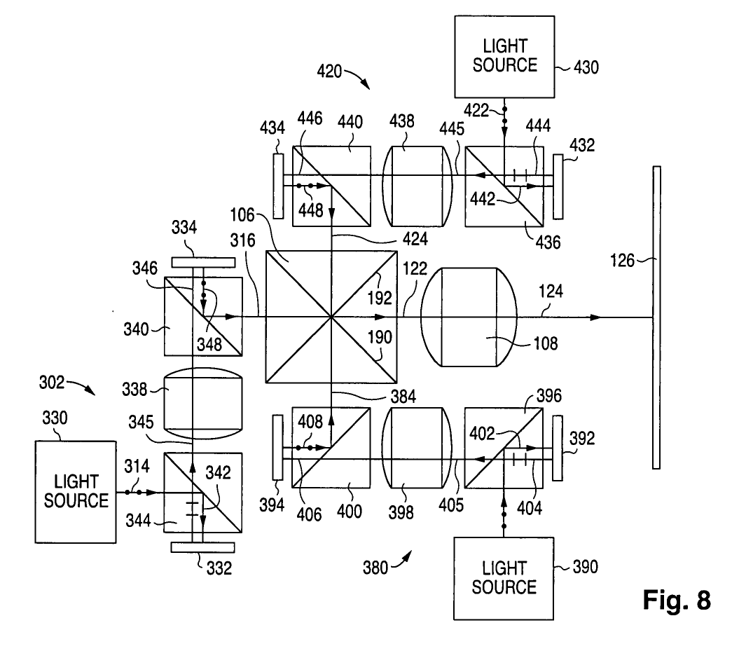

FIG. 8 illustrates another LCD trichromatic color light projector configured in accordance with the invention so as to employ fully reflective sequential modulation on light of all three colors, once again preferably red, green, and blue. The light projector of FIG. 8 consists of a double-modulating first optical assembly 420, double-modulating second optical assembly 302, double-modulating third optical assembly 380, X-cube beam combiner 106, and projection lens device 108. Double-modulating optical assemblies 302 and 380, X-cube 106, and projection lens 108 in the projector of FIG. 8 are deployed and operated the same as in the projector of FIG. 7. Double-modulating assembly 420 in the projector of FIG. 8 basically replaces single-modulating optical assembly 300 in the projector of FIG. 7.

Double-modulating optical assembly 420 sequentially doubly modulates a monochromatic primary beam 422 of s linearly polarized light of a selected one of the three colors in a fully reflective modulating manner to produce a modulated monochromatic further beam 424 of s linearly polarized light of the selected color. Modulated monochromatic further light beam 424 presents an image in the selected color. For the preferred case in which the three colors are red, green, and blue, modulated beam 424 of optical assembly 420 is blue light when modulated further beams 316 and 384 of optical assemblies 302 and 380 are respectively green light and red light or vice versa. In any event, doubly modulated beam 316, 384, or 424 of each assembly 302, 380, or 420 is a different one of red, green, and blue light.

Optical assembly 420 consists of a monochromatic light source 430, a first reflective light modulator 432, a second reflective light modulator 434, and light-directing structure formed with a first PBS 436, a relay lens 438, and a second PBS 440. Components 430, 432, 434, 436, 438, and 440 of optical assembly 420 are respectively deployed and operated the same as components 330, 332, 334, 336, 338, and 340 of optical assembly 302 except that assembly 420 processes light of a different color than assembly 302. Reference symbols 442, 444, 445, 446, and 448 in FIG. 8 identify, for optical assembly 420, beams of linearly polarized light respectively the same as linearly polarized light beams 342, 344, 345, 346, and 348 of optical assembly 302 except for the difference in light color.

Second PBS 440 of double-modulating optical assembly 420 is situated along the side of X-cube beam combiner 106 opposite the side where second PBS 400 of double-modulating optical assembly 380 is situated. Modulated monochromatic assembly output light beam 424 of s linearly polarized color light enters X-cube 106. Light of modulated beam 424 reflects off dichroic mirror 190 by approximately 90°, passes through dichroic mirror 192, and travels out of X-cube 106 generally along projection axis 124 into projection lens device 108. Since s linearly polarized color light of modulated monochromatic assembly output beams 316 and 384 also enters projection lens 108 along axis 124, light of beams 424, 316, and 384 combines to form composite trichromatic beam 122 of s linearly polarized color light.

Each of relay lenses 338, 398, and 438 in the projectors of FIGS. 6-8 handles light of a single color rather than multiple colors as occurs with relay lens 74 in Bridgwater's image display apparatus. The sensitivity of the projectors of FIGS. 6-8 to chromatic aberrations in any of lenses 338, 398, and 438 is thus less than the sensitivity of Bridgwater's image display apparatus to chromatic aberrations in lens 74. In addition, light passes through each of relay lenses 338, 398, and 438 in only one direction. Due to these factors, it is relatively easy to design relay lenses 338, 398, and 438 to provide the requisite light-directing optics. Hence, the components of each of the projectors of FIGS. 6-8 can be aligned quite easily. Furthermore, single-modulating optical assemblies 300 and 304 in the projectors of FIGS. 6 and 7 do not employ relay lenses, thereby avoiding relay-lens alignment problems.

Any of optical assemblies 100, 102, 104, 200, 240, 300, 302, 304, 380, or 420 in the projectors of FIGS. 3-8 can be rotated 90° (a quarter turn) around that assembly's output optical axis. The linearly polarized light of primary beam 110, 114, 118, 202, 242, 310, 314, 318, 382, or 422 and modulated beam 112, 116, 120, 204, 244, 312, 316, 320, 384, or 424 of each so-rotated assembly 100, 102, 104, 200, 240, 300, 302, 304, 380, or 420 is then of p linear polarization type (relative to X-cube beam combiner 106) rather than s linear polarization type. X-cube beam combiner 106 still combines light of the three modulated assembly output beams of each of those projectors to produce composite beam 122 of linearly polarized light. However, the light of composite beam 122 is of mixed s and p linear polarization types if one or two of the optical assemblies in any of the projectors are so rotated. The linearly polarized light of composite light beam 122 is all of p linear polarization type when all three of the optical assemblies in any of the projectors are rotated 90° about the assembly output optical axes.

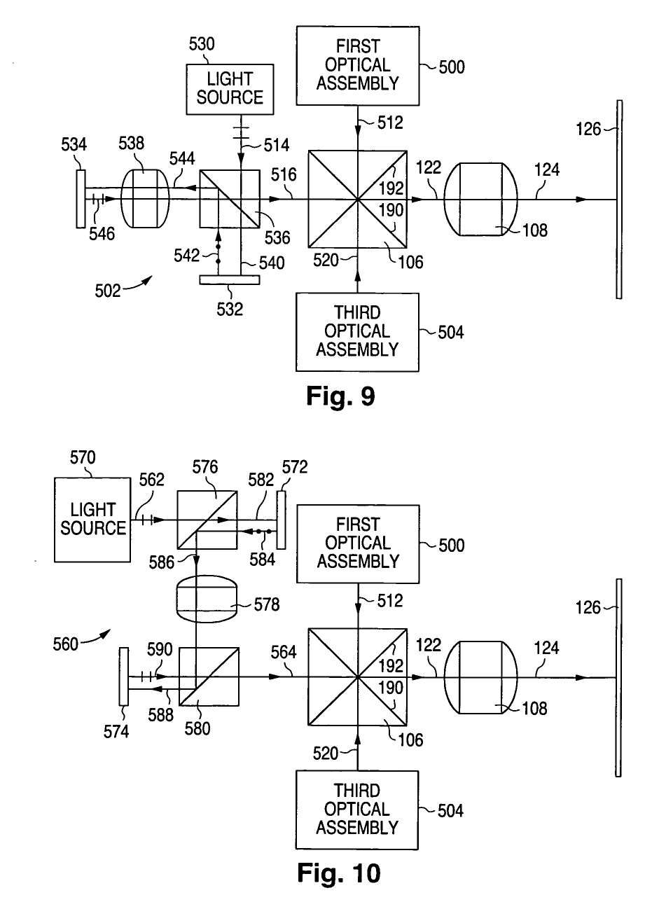

FIG. 9 illustrates an LCD trichromatic color light projector configured in accordance with the invention so as to employ fully reflective sequential modulation on light of at least one of the three colors. The light projector of FIG. 9 consists of a first optical assembly 500, a double-modulating second optical assembly 502, a third optical assembly 504, X-cube beam combiner 106, and projection lens device 108.

First optical assembly 500 modulates a monochromatic primary beam (not shown) of linearly polarized light of a selected one of the three colors to produce a modulated monochromatic further beam 512 of linearly polarized light of the selected color. Double-modulating second optical assembly 502 sequentially doubly modulates a monochromatic primary beam 514 of p linearly polarized light of a second selected one of the three colors in a fully reflective modulating manner to produce a modulated monochromatic further beam 516 of p linearly polarized light of the second selected color. Third optical assembly 504 modulates a monochromatic primary beam (not shown) of linearly polarized light of the remaining one of the three colors to produce a modulated monochromatic further beam 520 of linearly polarized light of the remaining color. Modulated monochromatic light beams 512, 516, and 520 present images in the three respective colors.

With the three colors again preferably being red, green, and blue, modulated beam 516 of double-modulating optical assembly 502 is preferably green light. Modulated beams 512 and 520 of remaining optical assemblies 500 and 504 are then respectively red light and blue light or vice versa.

X-cube beam combiner 106 combines light of modulated monochromatic assembly output beams 512, 516, and 520 to produce composite trichromatic beam 122 of linearly polarized color light. Since the linearly polarized light of modulated beam 516 provided by double-modulating optical assembly 502 is of p linear polarization type (rather than s linear polarization type as arises with modulated light beam 116 or 316 provided by double-modulating optical assembly 102 or 302), composite light beam 122 consists at least partially of p linearly polarized color light.

Each optical assembly 500 or 504 can be implemented in various ways to provide its modulated assembly output light beam 512 or 520 as a singly modulated beam or as a sequentially modulated beam, e.g., sequentially doubly modulated beam, and to provide modulated beam 512 or 520 as p linearly polarized color light or as s linearly polarized color light provided that the optical path from the location of final modulation in optical assembly 502 to X-cube 106 is substantially equivalent to the optical path from the location of final modulation (or equivalent operation) in each of optical assemblies 500 and 504 to X-cube 106.

As a first example, both of assemblies 500 and 504 can generate light beams 512 and 520 as singly modulated beams. More particularly, assemblies 500 and 504 can be respectively implemented as single-modulating optical assemblies 100 and 104 or as single-modulating optical assemblies 300 and 304 subject to making any adjustment needed to achieve substantially equivalent optical paths from the locations of final modulation (or equivalent operation in the case of optical assemblies 100 and 104) to X-cube beam combiner 106. Modulated beams 512 and 520 then consist of s linearly polarized color light. Since modulated beam 516 of double-modulating optical assembly 502 is formed with p linearly polarized light, composite light beam 122 is of mixed sps linear polarization.

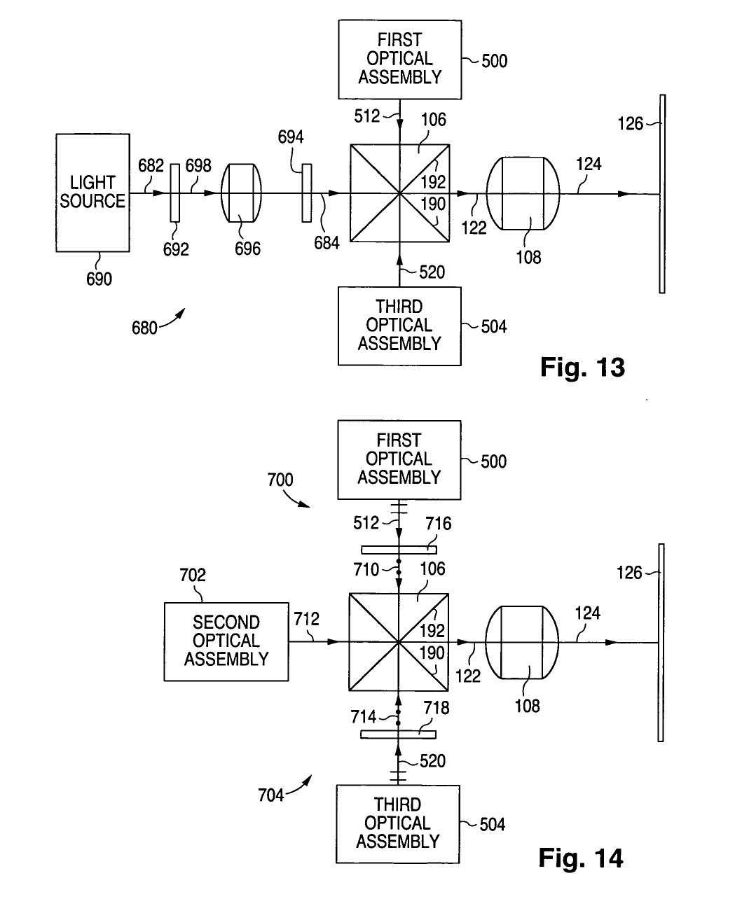

Optical assemblies 500 and 504 can also be implemented with the transmissive single-modulating implementations described below in connection with FIG. 13 subject to making adjustments to achieve substantially equivalent optical paths from the locations of final modulation to X-cube beam combiner 106. The linearly polarized light of modulated assembly output light beams 512 and 514 for these transmissive single-modulating implementations of optical assemblies 500 and 504 can, as described below, be of s or p linear polarization. Composite light beam 122 is then of totally s linear polarization or mixed psp linear polarization

With both of light beams 512 and 520 being singly modulated, these implementations of the projector of FIG. 9 utilize sequential modulation on light of one of the three colors and single modulation on light of each of the other two colors. Each of these implementations of the projector of FIG. 9 is then suitable for color projection applications in which high contrast ratio is needed for light of one of three colors but not for light of the other two colors.

As a second example, optical assemblies 500 and 504 can generate light beams 512 and 520 respectively as singly and doubly modulated beams. In particular, one of assemblies 500 and 504 can be respectively implemented essentially as single-modulating optical assembly 100 or 300 subject to the above-mentioned optical path considerations. The other of assemblies 500 and 504 can then be implemented essentially as double-modulating optical assembly 200 (or 102) or 380 (or 302) again subject to the above-mentioned optical path considerations. Both of light beams 512 and 520 again consist of s linearly polarized color light. Composite light beam 122 is again of mixed sps linear polarization.

One of assemblies 500 and 504 can be implemented essentially as single-modulating optical assembly 100 or 300 subject to the above-mentioned optical path considerations. The other of assemblies 500 and 504 can then be implemented essentially as double-modulating optical assembly 200 (or 102) or 380 (or 302) again subject to the above-mentioned optical path considerations. Both of light beams 512 and 520 again consist of s linearly polarized color light. Composite light beam 122 is again of mixed sps linear polarization.

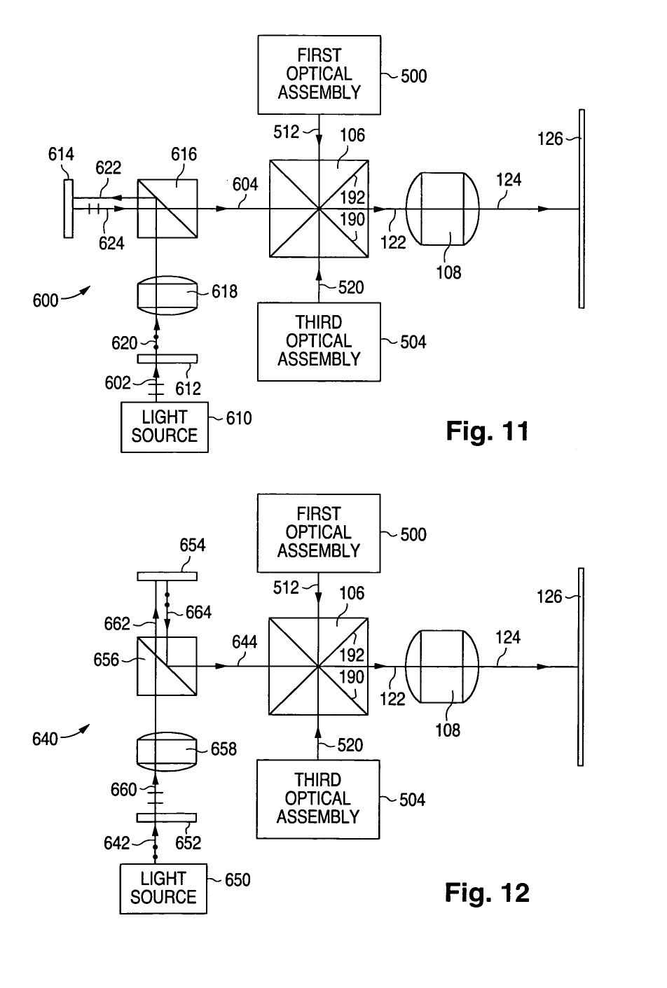

The double-modulating one of assemblies 500 and 504 can also be implemented with a replica of double-modulating optical assembly 502 or essentially with a replica of the double-modulating optical assembly of FIG. 10 or 11 subject to the above-mentioned optical path considerations. In each case, the sequentially doubly modulated one of light beams 512 and 520 is formed with p linearly polarized light. As a result, composite light beam 122 is of mixed pps or spp linear polarization.

Furthermore, the double-modulating one of assemblies 500 and 504 can be implemented essentially with a replica of the double-modulating optical assembly of FIG. 12 again subject to the above-mentioned optical path considerations. The sequentially doubly modulated one of light beams 512 and 520 is then formed with s linearly polarized light. Composite light beam 122 is of fully s linear polarization.

Yet further, one of assemblies 500 and 504 can be implemented essentially with the transmissive single-modulating implementation described below in connection with FIG. 13 subject to the above-mentioned optical path considerations. The other of assemblies 500 and 504 can then be implemented in any of the preceding ways for achieving sequential double modulation again subject to the above-mentioned optical path considerations. Since the singly modulated one of light beams 512 and 520 consists of s or p linearly polarized color light, the linear polarization of composite light beam 122 is totally p type, mixed pps, mixed spp, or mixed sps.

The preceding implementations of the projector of FIG. 9 in which light beams 512 and 520 are generated respectively as singly and doubly modulated beams utilize sequential modulation on light of two of three colors and single modulation on light of the third color. These implementations of the projector of FIG. 9 are thus suitable for color projection applications in which high contrast ratio is needed for light of two of three colors but not for light of the third color.

As a third example, both of assemblies 500 and 504 can generate light beams 512 and 520 as doubly modulated beams. More specifically, assemblies 500 and 504 can be respectively implemented essentially as double-modulating optical assemblies 240 and 200 or as double-modulating optical assemblies 420 and 380 subject to the above-mentioned optical path considerations. In that case, modulated beams 512 and 520 then consist of s linearly polarized color light. With modulated beam 516 of double-modulating optical assembly 502 formed with p linearly polarized light, composite light beam 122 is of mixed sps linear polarization.

Both of assemblies 500 and 504 can alternatively be implemented with replicas of double-modulating optical assembly 502 or essentially with replicas of the double-modulating optical assembly of FIG. 10, 11, 12, or 13 subject to the above-mentioned optical path considerations. Composite light beam 122 is then of mixed sps linear polarization or totally p linear polarization depending on whether modulated assembly output light beams 512 and 520 are of s linear polarization or of p linear polarization.

Again subject to the above-mentioned optical path considerations, one of assemblies 500 and 504 can be implemented with a replica of double-modulating optical assembly 502 or essentially with a replica of the double-modulating optical assembly of FIG. 10, 11, 12, or 13 while the other of assemblies 500 and 504 is implemented essentially with another of those double-modulating optical assemblies such that modulated light beams 512 and 514 are of opposite linear polarization types. In this case, composite light beam 120 is of mixed sps, pps, or spp linear polarization.

Double-modulating optical assembly 502 consists of a monochromatic light source 530, a first reflective light modulator 532, a second reflective light modulator 534, and light-directing structure formed with a PBS 536 and a relay lens 538. Light source 530 provides primary light beam 514 of p linearly polarized color light, preferably green light. PBS 136 transmits light of primary beam 514 to produce a transmitted beam 540 of p linearly polarized color light.

First modulator 532 reflectively modulates light of transmitted beam 540 to produce a reflected initial modulated beam 542 of s linearly polarized color light. Because incident light beam 540 is of p linear polarization type, modulator 532 causes initial modulated light beam 542 to be of the opposite linear polarization type to incident beam 540. PBS 536 reflects light of initial modulated beam 542 by approximately 90° to produce a first intermediate modulated beam 544 of s linearly polarized color light. Relay lens 538 directs light of first intermediate modulated beam 544 to second modulator 534.

Second modulator 534 reflectively modulates light of first intermediate modulated beam 544 to produce a reflected second intermediate modulated beam 546 of p linearly polarized color light. Second intermediate modulated beam 546 is thus fully reflectively sequentially doubly modulated. Since incident beam 544 is of s linear polarization type, modulator 534 causes second intermediate modulated light beam 546 to be of the opposite linear polarization type to incident beam 544. Relay lens 538 directs light of second intermediate modulated beam 546 to PBS 536. Light of second intermediate modulated beam 646 is then transmitted through PBS 536 to produce modulated beam 516 of s linearly polarized color light as the output beam of double-modulating optical assembly 502.

Optical assemblies 500 and 504 are situated along opposite sides of X-cube beam combiner 106. PBS 536 of double-modulating optical assembly 502 is situated along a third side of X-cube 106. Projection lens device 108 is situated along the side of X-cube 106 opposite PBS 536.

Modulated monochromatic assembly output light beams 512, 516, and 520 of linearly polarized color light enter X-cube beam combiner 106. Light of modulated beam 512 reflects off dichroic mirror 190 at approximately a 90° angle, passes through dichroic mirror 192, and travels out of X-cube 106 generally along projection optical axis 124 into projection lens device 108. Light of modulated beam 520 reflects off mirror 192 at approximately a 90° angle, passes through mirror 190, and travels out of X-cube 106 generally along projection axis 124 into projection lens 108. Light of modulated beam 516 passes through mirrors 190 and 192 and travels out of X-cube 106 generally along axis 124 into projection lens 108. As a result, light of beams 512, 516, and 520 combines to form composite trichromatic beam 122 of linearly polarized color light.

FIG. 10 illustrates another LCD trichromatic color light projector configured in accordance with the invention so as to employ fully reflective sequential modulation on light of at least one of the three colors. The light projector of FIG. 10 consists of first optical assembly 500, a double-modulating second optical assembly 560, third optical assembly 504, X-cube beam combiner 106, and projection lens device 108. Optical assemblies 500 and 504, X-cube 106, and projection lens 108 in the projector of FIG. 10 are deployed and operated the same as in the projector of FIG. 9.

Double-modulating optical assembly 560 sequentially doubly modulates a monochromatic primary beam 562 of p linearly polarized light of a selected one of the three colors in a fully reflective modulating manner to produce a modulated monochromatic further beam 564 of p linearly polarized light of the selected color. Modulated monochromatic further light beam 564 presents an image in the selected color. For the preferred case where the three colors are red, green, and blue, modulated beam 564 of double-modulating optical assembly 560 is preferably green light.

X-cube beam combiner 106 combines light of modulated monochromatic beams 512, 564, and 520 of linearly polarized color light to produce composite trichromatic beam 122 of linearly polarized color light. Since the linearly polarized color light of modulated beam 564 provided by double-modulating optical assembly 560 is of p linear polarization type, composite light beam 122 consists at least partially of p linearly polarized color light. Each optical assembly 500 or 504 in the projector of FIG. 10 can be implemented in various ways, including all of the ways described above in connection with the projector of FIG. 9. Consequently, the linear polarization of composite beam 122 in the projector of FIG. 10 is variously mixed sps, mixed pps, mixed spp, or totally p type.

Double-modulating optical assembly 562 consists of a monochromatic light source 570, a first reflective light modulator 572, a second reflective light modulator 574, and light-directing structure formed with a first PBS 576, a relay lens 578, and a second PBS 580. Light source 570 provides primary light beam 562 of p linearly polarized color light, preferably green light. First PBS 576 transmits light of primary beam 562 to produce a transmitted beam 582 of p linearly polarized color light.

First modulator 572 reflectively modulates light of transmitted beam 582 to produce a reflected initial modulated beam 584 of s linearly polarized color light. Since incident light beam 582 is of p linear polarization type, modulator 572 causes initial modulated light beam 584 to be of the opposite linear polarization type to incident beam 582. PBS 576 reflects light of initial modulated beam 584 by approximately 90° to produce a first intermediate modulated beam 586 of s linearly polarized light. Light of first intermediate modulated beam 586 is directed by relay lens 578 to second PBS 580 and then reflected by PBS 580 to produce a second intermediate modulated beam 588 of s linearly polarized light.

Second modulator 574 reflectively modulates light of second intermediate modulated beam 588 to produce a reflected third intermediate modulated beam 590 of p linearly polarized color light. Third intermediate modulated light beam 590 is thereby fully reflectively sequentially doubly modulated. Because incident beam 588 is of s linear polarization type, modulator 574 causes third intermediate modulated light beam 590 to be of the opposite linear polarization type to incident beam 588. Second PBS 580 then transmits light of third intermediate modulated beam 590 to produce modulated beam 564 of p linearly polarized color light as the output beam of double-modulating optical assembly 560.

Second PBS 580 of double-modulating optical assembly 560 is situated along the side of X-cube beam combiner 106 opposite projection lens device 108. Modulated monochromatic assembly output light beam 564 enters X-cube 106. Light of modulated beam 564 passes through dichroic mirrors 190 and 192 and travels out of X-cube 106 generally along projection axis 124 into projection lens 108. Since linearly polarized color light of modulated monochromatic assembly output beams 512 and 520 also enters projection lens 108 along axis 124, light of beams 512, 564, and 520 combines to form composite trichromatic beam 122 of linearly polarized color light.

FIG. 11 illustrates an LCD trichromatic color light projector configured in accordance with the invention so as to employ transmissive-reflective sequential modulation on light of at least one of the three colors. The light projector of FIG. 11 consists of first optical assembly 500, a double-modulating second optical assembly 600, third optical assembly 504, X-cube beam combiner 106, and projection lens device 108. Optical assemblies 500 and 504, X-cube 106, and projection lens 108 in the projector of FIG. 11 are deployed and operated the same as in the projector of FIG. 9.

Double-modulating optical assembly 600 sequentially doubly modulates a monochromatic primary beam 602 of linearly polarized light of a selected one of the three colors in a transmissive-reflective modulating manner to produce a modulated monochromatic further beam 604 of p linearly polarized light of the selected color. Modulated monochromatic further light beam 604 presents an image in the selected color. With the three colors preferably being red, green, and blue, modulated beam 604 of double-modulating optical assembly 600 is preferably green light. The color light of primary beam 602 is of p linear polarization in the example of FIG. 11. However, primary beam 602 can be of s linear polarization.

X-cube beam combiner 106 combines light of modulated monochromatic beams 512, 604, and 520 of linearly polarized color light to produce composite trichromatic beam 122 of linearly polarized color light. Each optical assembly 500 or 504 in the projector of FIG. 11 can again be implemented in various ways, including all of the ways described above in connection with the projector of FIG. 9. Inasmuch as the linearly polarized light of modulated beam 604 provided by double-modulating optical assembly 600 is of p linear polarization type, the linear polarization of composite light beam 122 in the projector of FIG. 11 is totally p type, mixed pps, mixed spp, or mixed sps.

Double-modulating optical assembly 600 consists of a monochromatic light source 610, a transmissive (first) light modulator 612, a reflective (second) light modulator 614, and light-directing structure formed with a PBS 616 and a relay lens 618. Light source 610 provides primary light beam 602 of linearly polarized color light. Once again, the color light of primary beam 602 is p type in the example of FIG. 11.

Transmissive modulator 612 transmissively modulates light of primary beam 602 to produce a transmitted initial modulated beam 620 of s linearly polarized color light. When primary beam 602 is formed with p linearly polarized light, modulator 612 causes the color light of initial modulated light beam 620 to be of the opposite linear polarization type to incident beam 602. Modulator 612 causes the color light of initial modulated light beam 620 to be of the same linear polarization type as incident beam 602 when it is formed with s linearly polarized light. Light of initial modulated beam 620 is directed by relay lens 618 to PBS 616 and reflected by approximately 90° by PBS 616 to produce a first intermediate modulated beam 622 of s linearly polarized light.

Reflective modulator 614 reflectively modulates light of first intermediate modulated beam 622 to produce a reflected second intermediate modulated beam 624 of p linearly polarized color light. Second intermediate modulated light beam 624 is thus transmissively/reflectively sequentially doubly modulated. Modulator 614 causes second intermediate modulated light beam 624 to be of the opposite linear polarization type to incident beam 622. Light of second intermediate modulated beam 624 is transmitted through PBS 616 to produce modulated beam 604 of p linearly polarized color light as the output beam of double-modulating optical assembly 600. Doubly modulated assembly output light beam 604 is of the same linear polarization type as second intermediate modulated light beam 624.

PBS 616 of double-modulating optical assembly 600 is situated along the side of X-cube beam combiner 106 opposite projection lens device 108. Modulated monochromatic assembly output light beam 604 enters X-cube 106. Light of modulated beam 604 passes through dichroic mirrors 190 and 192 and travels out of X-cube 106 generally along projection axis 124 into projection lens 108. With linearly polarized color light of modulated monochromatic assembly output beams 512 and 520 also entering projection lens 108 along axis 124, light of beams 512, 604, and 520 combines to form composite trichromatic beam 122 of linearly polarized color light.

FIG. 12 illustrates another LCD trichromatic color light projector configured in accordance with the invention so as to employ transmissive-reflective sequential modulation on light of at least one of the three colors. The light projector of FIG. 12 consists of first optical assembly 500, a double-modulating second optical assembly 640, third optical assembly 504, X-cube beam combiner 106, and projection lens device 108. Optical assemblies 500 and 504, X-cube 106, and projection lens 108 in the projector of FIG. 12 are once again deployed and operated the same as in the projector of FIG. 9.

Double-modulating optical assembly 640 sequentially doubly modulates a monochromatic primary beam 642 of linearly polarized light of a selected one of the three colors in a transmissive-reflective modulating manner to produce a modulated monochromatic further beam 644 of s linearly polarized light of the selected color. Modulated monochromatic further light beam 644 presents an image in the selected color. For the preferred situation in which the three colors again are red, green, and blue, modulated beam 644 of double-modulating optical assembly 640 is preferably green light. Similar to optical assembly 600 in the projector of FIG. 11, the color light of primary beam 642 in optical assembly 640 can be of p or s linear polarization. FIG. 12 depicts the example in which primary beam 642 is s type.

X-cube beam combiner 106 combines light of modulated monochromatic beams 512, 644, and 520 of linearly polarized color light to produce composite trichromatic beam 122 of linearly polarized color light. Each optical assembly 500 or 504 in the projector of FIG. 12 can once again be implemented in various ways, including all of the ways described above in connection with the projector of FIG. 9. Because the linearly polarized light of modulated beam 644 provided by double-modulating optical assembly 640 is of s linear polarization type, the linear polarization of composite light beam 122 in the projector of FIG. 12 is totally s type, mixed pss, mixed ssp, or mixed psp.

Double-modulating optical assembly 640 consists of a monochromatic light source 650, a transmissive (first) light modulator 652, a reflective (second) light modulator 654, and a light-directing structure formed with a PBS 656 and a relay lens 658. Light source 650 provides primary light beam 642 of s linearly polarized color light.

Transmissive modulator 652 transmissively modulates light of primary beam 642 to produce a transmitted initial modulated beam 660 of p linearly polarized color light. When primary beam 642 is formed with s linearly polarized light, modulator 652 causes the color light of initial modulated light beam 660 to be of the opposite linear polarization type to incident beam 642. Modulator 652 causes the color light of initial modulated light beam 660 to be of the same linear polarization type as incident beam 642 when it is formed with p linearly polarized light. Light of initial modulated beam 660 is directed by relay lens 658 to PBS 656 and transmitted by PBS 656 to produce a first intermediate modulated beam 662 of p linearly polarized light.

Reflective modulator 654 reflectively modulates light of first intermediate modulated beam 662 to produce a reflected second intermediate modulated beam 664 of s linearly polarized color light. Second intermediate modulated light beam 664 is therefore transmissively/reflectively sequentially doubly modulated. Modulator 654 causes second intermediate modulated light beam 664 to be of the opposite linear polarization type to incident beam 662. PBS 656 reflects light of second intermediate modulated beam 664 by approximately 90° to produce modulated beam 644 of s linearly polarized color light as the output beam of double-modulating optical assembly 640. Doubly modulated assembly output light beam 644 is of the same linear polarization type as second intermediate modulated light beam 664.

PBS 656 of double-modulating optical assembly 640 is situated along the side of X-cube beam combiner 106 opposite projection lens device 108. Modulated monochromatic assembly output light beam 644 enters X-cube 106. Light of modulated beam 644 passes through dichroic mirrors 190 and 192 and travels out of X-cube 106 generally along projection axis 124 into projection lens 108. Since linearly polarized color light of modulated monochromatic assembly output beams 512 and 520 also enters projection lens 108 along axis 124, light of beams 512, 644, and 520 combines to form composite trichromatic beam 122 of linearly polarized color light.

Any of double-modulating optical assemblies 502, 560, 600, and 640 in the projectors of FIGS. 9-12 can be rotated by 90° about its output optical axis. This causes assembly output light beam 516, 564, or 604 of optical assembly 502, 600, or 640 to be of s linear polarization type. The linear polarization of composite beam 122 in the projector of FIG. 9, 10, 11, or 12 is then variously totally s type, totally p type, or any three-part mixture of s and p types.

FIG. 13 illustrates an LCD trichromatic color light projector configured in accordance with the invention so as to employ fully transmissive sequential modulation on light of at least one of the three colors. The light projector of FIG. 13 consists of first optical assembly 500, a double-modulating second optical assembly 680, third optical assembly 504, X-cube beam combiner 106, and projection lens device 108. Optical assemblies 500 and 504, X-cube 106, and projection lens 108 in the projector of FIG. 12 are once again deployed and operated the same as in the projector of FIG. 9.

Double-modulating optical assembly 680 sequentially doubly modulates a monochromatic primary beam 682 of s or p linearly polarized light of a selected one of the three colors in a fully transmissive modulating manner to produce a modulated monochromatic further beam 684 of linearly polarized light of the selected color. Modulated monochromatic further light beam 684, which is of the same linear polarization type as primary light beam 682, presents an image in the selected color. In the preferred situation where the three colors are red, green, and blue, modulated beam 684 of double-modulating optical assembly 680 is preferably green light.

X-cube beam combiner 106 combines light of modulated monochromatic beams 512, 684, and 520 of linearly polarized color light to produce composite trichromatic beam 122 of linearly polarized color light. Each optical assembly 500 or 504 in the projector of FIG. 13 can be implemented in various ways, including all of the ways described above in connection with the projector of FIG. 9. Since modulated beam 684 can be of s or p linear polarization type, the linear polarization of composite beam 122 in the projector of FIG. 13 is variously totally s type, totally p type, or any three-part mixture of s and p types.

Double-modulating optical assembly 680 consists of a monochromatic light source 690, a first transmissive light modulator 692, a second transmissive light modulator 694, and a light-directing structure formed with a relay lens 696. Light source 690 provides primary light beam 682 of s or p linearly polarized color light.

Transmissive modulator 692 transmissively modulates light of primary beam 682 to produce a transmitted initial modulated beam 698 of linearly polarized color light of the same linear polarization type as, or the opposite linear polarization type to, incident beam 682. Light of initial modulated beam 698 is directed by relay lens 696 to transmissive modulator 694.

Transmissive modulator 694 transmissively modulates light of initial modulated beam 698 to produce transmitted modulated beam 684 of linearly polarized color light as the output beam of double-modulating optical assembly 680. Modulator 694 causes modulated output light beam 684 to be of the same linear polarization type as, or the opposite linear polarization type to incident beam 698. Since modulator 692 similarly causes initial modulated light beam 698 to be of the same linear polarization type as, or the opposite linear polarization type to, primary light beam 682, doubly modulated assembly output light beam 684 can be of the same linear polarization type as, or the opposite linear polarization type to, primary beam 682.

Second modulator 694 of double-modulating optical assembly 680 is situated along the side of X-cube beam combiner 106 opposite projection lens device 108. Modulated monochromatic assembly output light beam 684 enters X-cube 106. Light of modulated beam 684 passes through dichroic mirrors 190 and 192 and travels out of X-cube 106 generally along projection axis 124 into projection lens 108. With linearly polarized color light of modulated monochromatic assembly output beams 512 and 520 also entering projection lens 108 along axis 124, light of beams 512, 684, and 520 combines to form composite trichromatic beam 122 of linearly polarized color light.

In one implementation of the light projector of FIG. 13, each of single-modulating optical assemblies 500 and 504 consists of a light source (not shown) and a transmissive light modulator (also not shown). The light source provides a primary light beam of p or s linearly polarized color light. The transmissive modulator transmissively modulates light of the primary beam to produce transmitted modulated beam 512 or 520 of linearly polarized color light as the output beam of single-modulating optical assembly 500 or 504. In the modulation process, the transmissive modulator causes the modulated assembly output light beam to be of the same linear polarization type as, or the opposite linear polarization type to, the primary light beam. The transmissive modulators are situated along the two sides of X-cube beam combiner 106 where modulated beams 512 and 120 respectively enter X-cube 106.

As described above, dichroic mirrors 190 and 192 in X-cube beam combiner 106 transmit light of modulated output light beams 116, 316, 516, 564, 604, 644, and 684 of second optical assemblies 102, 302, 502, 560, 600, 640, and 680 in the projectors of FIGS. 3-13. Currently available X-cube beam combiners suitable for X-cube 106 efficiently transmit linearly polarized green light of both s type and p type. Since output beams 116, 316, 516, 564, 604, 644, and 684 of second optical assemblies 102, 302, 502, 560, 600, 640, and 680 all preferably consist of s or p linearly polarized green light, the efficiency of X-cube 106 with respect to second assemblies 102, 302, 502, 560, 600, 640, and 680 is high in the preferred implementations of the projectors of FIGS. 3-13 regardless of whether the linearly polarized light of assembly output beams 116, 316, 516, 564, 604, 644, and 684 is s or p type.

As also described above, dichroic mirror 190 reflects light of modulated output beams 112, 244, 312, 424, and 512 of first optical assemblies 100, 240, 300, 420, and 500 in the course of transmitting light of modulated output beams 120, 204, 320, 384, and 520 of third optical assemblies 104, 200, 304, 380, and 504 while dichroic mirror 192 reflects light of output beams 120, 204, 320, 384, and 520 of third assemblies 104, 200, 304, 380, and 504 in the course of transmitting light of output beams 112, 244, 312, 424, and 512 of first assemblies 100, 240, 300, 420, and 500. Currently available X-cube beam combiners suitable for X-cube 106 efficiently reflect s linearly polarized red and green light but commonly do not efficiently reflect p linearly polarized red and green light. Output beams 112, 120, 204, 244, 312, 312, 384, and 424 of first/third optical assemblies 100, 104, 204, 240, 300, 304, 380, and 420 variously consist of red and green linearly polarized light which is of s linear polarization in the preferred implementations of the projectors of FIGS. 3-8. Consequently, the efficiency of X-cube 106 with respect to first/third optical assemblies 100, 104, 204, 240, 300, 304, 380, and 420 is also high in the preferred implementations of the projectors of FIGS. 3-8.

Output beams 512 and 520 of first/third optical assemblies 500 and 504 consist respectively of red and blue linearly polarized light which is of p linear polarization in certain implementations of the projectors of FIGS. 9-13. Since currently available X-cube beam combiners suitable for X-cube beam combiner 106 commonly do not efficiently reflect p linearly polarized red and blue light, the efficiency of X-cube 106 may be undesirable low in implementations of the projectors of FIGS. 9-13 where (i) output beams 512 and 520 of first/third assemblies 500 and 504 are formed with red and blue p linearly polarized light and (i) X-cube 106 is implemented with a currently available X-cube beam combiner. This matter is addressed with the LCD trichromatic color light projector illustrated in FIG. 14.

The projector of FIG. 14 is configured in accordance with the invention so as to employ sequential modulation on light of at least one of three colors. The sequential modulation can be fully reflective, transmissive-reflective, or fully transmissive. The light projector of FIG. 14 consists of a first optical assembly 700, a double-modulating second optical assembly 702, a third optical assembly 704, X-cube beam combiner 106, and projection lens device 108.

First optical assembly 700 modulates a monochromatic primary beam (not shown) of linearly polarized light of a selected one of three colors to produce a modulated monochromatic beam 710 of polarized light of the selected color. Double-modulating second optical assembly 702 sequentially doubly modulates a monochromatic primary beam (also not shown) of s or p linearly polarized light of a second selected one of the three colors in a fully reflective, transmissive-reflective, or fully transmissive modulating manner to produce a modulated monochromatic further beam 712 of linearly polarized light of the selected color. Third optical assembly 704 modulates a monochromatic primary beam (likewise not shown) of linearly polarized light of the remaining one of the three colors to produce a modulated monochromatic further beam 714 of polarized light of the remaining color. Modulated monochromatic light beams 710, 712, and 714 present images in the three respective colors.

Double-modulating second optical assembly 702 is formed by any of double-modulating optical assemblies 102, 302, 502, 560, 600, 640, 640, and 680 of the projectors of FIGS. 3-13. Accordingly, output beam 712 of second assembly 702 preferably consists of (i) s linearly polarized green light when assembly 702 is implemented with assembly 102, 302, or 640 or an implementation of assembly 680 in which its output light beam 684 is formed with s linearly polarized green light or (ii) p linearly polarized light when assembly 702 is implemented with assembly 502, 560, or 600 or an implementation of assembly 680 in which its output light beam 684 is formed with p linearly polarized green light.

First optical assembly 700 generates assembly output light beam 710 as a singly modulated beam or as a sequentially doubly modulated beam. In either case, first assembly 710 consists of first optical assembly 500 and a partial-wave retardation plate 716. First assembly 500 in the projector of FIG. 14 is implemented with any of the above-described optical assemblies by which modulated output beam 512 of assembly 500 is generated as p linearly polarized monochromatic color light, normally red or blue. Retardation plate 716 operates on the p linearly polarized color light of modulated beam 512 to produce modulated assembly output beam 710 as s linearly polarized color light or as circularly polarized color light.

FIG. 14 depicts the example in which output beam 710 of first optical assembly 700 consists of s linearly polarized color light. In that case, retardation plate 716 is a half-wave retardation plate. Retardation plate 716 is a quarter-wave retardation plate when modulated assembly output beam 710 consists of circularly polarized color light.

Similar to first optical assembly 700, third optical assembly 704 generates assembly output light beam 714 as a singly modulated beam or as a sequentially doubly modulated beam. For this purpose, third assembly 714 consists of first optical assembly 504 and a partial-wave retardation plate 718. Components 504 and 718 of third assembly 704 are respectively deployed and operated the same as components 500 and 716 of first assembly 700 except that assembly 704 processes light of a different color than assembly 700. In the preferred case where assembly 700 processes one of red light and blue light, assembly 704 processes the other of red light and blue light.

Retardation plates 716 and 718 of first/third optical assemblies 700 and 704 are situated along opposite sides of X-cube beam combiner 106. Double-modulating second optical assembly 702 is situated along a third side of X-cube 106 opposite projection lens device 108.

Modulated monochromatic assembly output beams 710 and 714 of s linearly polarized or circularly polarized color light enter X-cube beam combiner 106 along with modulated monochromatic assembly output beam 712 of s or p linearly polarized color light. Light of modulated beam 710 reflects off dichroic mirror 190 at approximately a 90° angle, passes through dichroic mirror 192, and travels out of X-cube 106 generally along projection optical axis 124 into projection lens device 108. Light of modulated beam 714 reflects off mirror 192 at approximately a 90° angle, passes through mirror 190, and travels out of X-cube 106 generally along projection axis 124 into projection lens 108. Light of modulated beam 712 passes through mirrors 190 and 192 and travels out of X-cube 106 generally along axis 124 into projection lens 108. Light of beams 710, 712, and 714 thereby combines to form composite trichromatic light beam 122. Depending on whether the light of output beam 712 of double-modulating second optical assembly 702 is of s or p linear polarization and on whether output beam 710 or 714 of each first/third optical assembly 700 or 704 consists of s linearly polarized or circularly polarized light, composite light beam 122 is variously of totally s linear polarization, mixed sps linear polarization, or a mixture of circularly polarized and s or/and p linearly polarized light.

In addition to efficiently reflecting s linearly polarized red and blue light, currently available X-cube beam combiners suitable for implementing X-cube beam combiner 106 efficiently reflect circularly polarized red and blue light. Although currently available X-cube beam combiners commonly do not efficiently reflect p linearly polarized red and blue light, the color light which forms assembly output beams 710 and 714 and which is reflected by dichroic mirrors 190 and 192 in X-cube beam combiner 106 consists of (i) s linearly polarized red and blue light, (ii) circularly polarized red and blue light, or (iii) s linearly polarized red or blue light and circularly polarized blue or red light. As a result, the efficiency of X-cube 106 with respect to first/third optical assemblies 700 and 704 is high so that the overall efficiency of X-cube 106 is high.

While the invention has been described with reference to particular embodiments, this description is solely for the purpose of illustration and is not to be construed as limiting the scope of the invention claimed below. For instance, light-reflective modulators 132, 134, 152, 172, 212, 214, 252, 254, 332, 334, 352, 362, 392, 394, 432, 434, 532, 534, 572, 574, 614, and 654 can be variously implemented with light-reflective modulating devices other than reflective LCDs. Light-transmissive modulators 612, 652, 692, and 694 can be variously implemented with light-transmissive modulating devices other than transmissive LCDs. Various modifications and applications may thus be made by those skilled in the art without departing from the true scope of the invention as defined in the appended claims.

I claim:

1. A light projector comprising:
a plurality of optical assemblies for respectively modulating light of a like plurality of primary beams of linearly polarized light to respectively produce a like plurality of further beams of modulated light, each of at least one, but not all, of the optical assemblies sequentially modulating light of its primary beam;
a beam combiner for combining light of the further beams to produce a composite beam of light; and
a projection lens device for projecting light of the composite beam.

2. A projector as in claim 1 wherein each optical assembly that sequentially modulates light of its primary beam sequentially modulates light of its primary light beam substantially independently of any other optical assembly that sequentially modulates light of its primary beam.

3. A projector as in claim 2 wherein each optical assembly that sequentially modulates light of its primary beam comprises:
a source of the primary beam of that optical assembly;
a first modulator for modulating light of the primary beam of that optical assembly to produce an intermediate beam of light; and
a second modulator for modulating light of the intermediate beam to produce light constituting the further beam of that optical assembly; and
light-directing structure for variously directing light to, between, and away from the source and the first and second modulators.

4. A projector as in claim 3 wherein each modulator comprises a liquid-crystal display.

5. A projector as in claim 3 wherein the second modulator of each optical assembly that sequentially modulates light of its primary beam reflectively modulates light of its intermediate beam to produce its further beam.

6. A projector as in claim 5 wherein the first modulator of each optical assembly that sequentially modulates light of its primary beam reflectively modulates light of its primary beam to produce its intermediate beam.

7. A projector as in claim 6 wherein the light-directing structure of each optical assembly that sequentially modulates light of its primary beam comprises a polarization beam splitter for reflecting light of the primary beam of that optical assembly to produce a reflected beam of light, the first modulator of that optical assembly reflectively modulating light of the reflected beam to produce the intermediate beam of that optical assembly, light of the intermediate beam of that optical assembly being transmitted through the polarization beam splitter to the second modulator of that optical assembly and, after being reflectively modulated by the second modulator of that optical assembly, being reflected by the polarization beam splitter to produce light constituting the further beam of that optical assembly.

8. A projector as in claim 6 wherein the light-directing structure of each optical assembly that sequentially modulates light of its primary beam comprises:
a first polarization beam splitter for reflecting light of the primary beam of that optical assembly to produce a first reflected beam of light, the first modulator of that optical assembly reflectively modulating light of the reflected beam to produce the intermediate beam of that optical assembly; and
a second polarization beam splitter, light of the intermediate beam of that optical assembly being transmitted through the second polarization beam splitter and, after being reflectively modulated by the second modulator of that optical assembly, being reflected by the polarization beam splitter to produce light constituting the further beam of that optical assembly.

9. A projector as in claim 6 wherein the light-directing structure of each optical assembly that sequentially modulates light of its primary beam comprises a polarization beam splitter for transmitting light of the primary beam of that optical assembly to produce a transmitted beam of light, the first modulator of that optical assembly reflectively modulating light of the transmitted beam to produce the intermediate beam of that optical assembly, light of the intermediate beam of that optical assembly being reflected by the polarization beam splitter and, after being reflectively modulated by the second modulator of that optical assembly, being transmitted through the polarization beam splitter to produce light constituting the further beam of that optical assembly.

10. A projector as in claim 6 wherein the light-directing structure of each optical assembly that sequentially modulates light of its primary beam comprises:
a first polarization beam splitter for transmitting light of the primary beam of that optical assembly to produce a first transmitted beam of light, the first modulator of that optical assembly reflectively modulating light of the transmitted beam to produce the intermediate beam of that optical assembly; and
a second polarization beam splitter, light of the intermediate beam of that optical assembly being reflected by the second polarization beam splitter and, after being reflectively modulated by the second modulator of that optical assembly, being transmitted through the second polarization beam splitter to produce light constituting the further beam of that optical assembly.

11. A projector as in claim 5 wherein the first modulator of each optical assembly that sequentially modulates light of its primary beam transmissively modulates light of its primary beam to produce its intermediate beam.

12. A projector as in claim 11 wherein the light-directing structure of each optical assembly that sequentially modulates light of its primary beam comprises a polarization beam splitter for reflecting light of the intermediate beam of that optical assembly to produce a reflected beam of light, light of the reflected beam of that optical assembly being reflectively modulated by the second modulator of that optical assembly and then being transmitted through the polarization beam splitter to produce light constituting the further beam of that optical assembly.

13. A projector as in claim 11 wherein the light-directing structure of each optical assembly that sequentially modulates light of its primary beam comprises a polarization beam splitter for transmitting light of the intermediate beam of that optical assembly to produce a transmitted beam of light, light of the transmitted beam of that optical assembly being reflectively modulated by the second modulator of that optical assembly and then being reflected by the polarization beam splitter to produce light constituting the further beam of that optical assembly.

14. A projector as in claim 5 wherein each other optical assembly comprises:
a source of the primary beam of that other optical assembly;
an additional modulator for reflectively modulating light of the primary beam of that other optical assembly to produce a modulated first intermediate beam of linearly polarized light;
a quarter-wave retardation plate for converting light of the first intermediate beam into a second intermediate beam of circularly polarized light;
a light reflector for reflecting light of the second intermediate beam to produce a third intermediate beam of circularly polarized light of opposite polarization handedness to the circularly polarized light of the second intermediate beam, the retardation plate converting light of the third intermediate beam into light constituting the further beam of that other optical assembly; and
light-directing structure for variously directing light to, between, and away from the source, the additional modulator, the retardation plate, and the light reflector.

15. A projector as in claim 14 wherein the light-directing structure of each such other optical assembly comprises a polarization beam splitter for reflecting light of the primary beam of that other optical assembly to produce a reflected beam of light, light of the reflected beam being modulated by the additional modulator of that other optical assembly to produce the first intermediate beam of that other optical assembly, light of the first intermediate beam of that other optical assembly being transmitted through the polarization beam splitter.

16. A projector as in claim 5 wherein each other optical assembly comprises:
a source of the primary beam of that other optical assembly;
an additional modulator for reflectively modulating light of the primary beam of that other optical assembly to produce modulated light constituting the further beam of that other optical assembly; and
light-directing structure for variously directing light to, between, and away from the source and the additional modulator.

17. A projector as in claim 16 wherein the light-directing structure of each such other optical assembly comprises a polarization beam splitter for transmitting light of the primary beam of that other optical assembly to produce a transmitted beam of light, light of the transmitted beam being modulated by the additional modulator of that other optical assembly and then being reflected by the polarization beam splitter to produce the further beam of that other optical assembly.

18. A projector as in claim 3 wherein the second modulator of each optical assembly that sequentially modulates light of its primary beam causes its further beam to be of opposite linear polarization type to its intermediate beam.

19. A projector as in claim 1 wherein:
there are three of the optical assemblies; and
only one of the three optical assemblies sequentially modulates light of its primary beam in producing its further beam.

20. A projector as in claim 19 wherein:
the further beam of the optical assembly that sequentially modulates light of its primary beam comprises green light; and
the further beams of the other two optical assemblies respectively comprise red light and blue light.

21. A projector as in claim 19 wherein the optical assembly that sequentially modulates light of its primary beam comprises:
a source of the primary beam of that optical assembly;
a first modulator for modulating light of the primary beam of that optical assembly to produce an intermediate beam of light;
a second modulator for reflectively modulating light of the intermediate beam to produce light constituting the further beam of that optical assembly; and
light-directing structure for variously directing light to, between, and away from the source and the first and second modulators.

22. A projector as in claim 1 wherein:
there are three of the optical assemblies; and
two of the three optical assemblies sequentially modulate light of their primary beams in producing their further beams, each of these two optical assemblies sequentially modulating light of its primary beam substantially independent of the other of these two optical assemblies.

23. A projector as in claim 22 wherein:
the further beams of the two optical assemblies that sequentially modulate light of their primary beams respectively comprise green light and red light; and
the further beam of the other optical assembly comprises blue light.

24. A projector as in claim 22 wherein each optical assembly that sequentially modulates light of its primary beam comprises:
a source of the primary beam of that optical assembly;
a first modulator for modulating light of the primary beam of that optical assembly to produce an intermediate beam of light;
a second modulator for reflectively modulating light of the intermediate beam to produce light constituting the further beam of that optical assembly; and
light-directing structure for variously directing light to, between, and away from the source and the first and second modulators.

25. A light projector comprising:
three optical assemblies for respectively sequentially modulating light of three primary beams of linearly polarized light to respectively produce three further beams of modulated light;
an X-cube beam combiner for combining light of the further beams to produce a composite beam of light; and
a projection lens device for projecting light of the composite beam.

26. A projector as in claim 25 wherein each optical assembly reflectively sequentially modulates light of its primary beam.

27. A projector as in claim 25 wherein each optical assembly comprises:
a source of the primary beam of that optical assembly;
a first modulator for modulating light of the primary beam of that optical assembly to produce an intermediate beam of light;
a second modulator for reflectively modulating light of the intermediate beam to produce light constituting the further beam of that optical assembly; and
light-directing structure for variously directing light to, between, and away from the source and the first and second modulators.

28. An optical assembly as in claim 27 wherein each modulator comprises a liquid-crystal display.

29. A projector as in claim 27 wherein the first modulator of each optical assembly that sequentially modulates light of its primary beam reflectively modulates light of its primary beam to produce its intermediate beam.

30. A projector as in claim 29 wherein the light-directing structure of each optical assembly comprises a polarization beam splitter for reflecting light of the primary beam of that optical assembly to produce a reflected beam of light, the first modulator of that optical assembly modulating light of the reflected beam to produce the intermediate beam of that optical assembly, light of the intermediate beam of that optical assembly being transmitted through the polarization beam splitter to the second modulator of that optical assembly and, after being reflectively modulated by the second modulator of that optical assembly, being reflected by the polarization beam splitter to produce light constituting the further beam of that optical assembly.

31. A projector as in claim 29 wherein the light-directing structure of each optical assembly comprises:
a first polarization beam splitter for reflecting light of the primary beam of that optical assembly to produce a first reflected beam of light, the first modulator of that optical assembly modulating light of the reflected beam to produce the intermediate beam of that optical assembly; and
a second polarization beam splitter, light of the intermediate beam of that optical assembly being transmitted through the second polarization beam splitter and, after being reflectively modulated by the second modulator of that optical assembly, being reflected by the polarization beam splitter to produce light constituting the further beam of that optical assembly.

32. A projector as in claim 29 wherein the light-directing structure of each optical assembly comprises a polarization beam splitter for transmitting light of the primary beam of that optical assembly to produce a transmitted beam of light, the first modulator of that optical assembly modulating light of the transmitted beam to produce the intermediate beam of that optical assembly, light of the intermediate beam of that optical assembly being reflected by the polarization beam splitter and, after being reflectively modulated by the second modulator of that optical assembly, being transmitted through the polarization beam splitter to produce light constituting the further beam of that optical assembly.

33. A projector as in claim 29 wherein the light-directing structure of each optical assembly comprises:
a first polarization beam splitter for transmitting light of the primary beam of that optical assembly to produce a first transmitted beam of light, the first modulator of that optical assembly modulating light of the transmitted beam to produce the intermediate beam of that optical assembly; and
a second polarization beam splitter, light of the intermediate beam of that optical assembly being reflected by the second polarization beam splitter and, after being reflectively modulated by the second modulator of that optical assembly, being transmitted through the second polarization beam splitter to produce light constituting the further beam of that optical assembly.

34. A projector as in claim 27 wherein the first modulator of each optical assembly that sequentially modulates light of its primary beam transmissively modulates light of its primary beam to produce its intermediate beam.

35. A projector as in claim 34 wherein the light-directing structure of each optical assembly that sequentially modulates light of its primary beam comprises a polarization beam splitter for reflecting light of the intermediate beam of that optical assembly to produce a reflected beam of light, light of the reflected beam of that optical assembly being reflectively modulated by the second modulator of that optical assembly and then being transmitted through the polarization beam splitter to produce light constituting the further beam of that optical assembly.

36. A projector as in claim 35 wherein the light-directing structure of each optical assembly that sequentially modulates light of its primary beam comprises a polarization beam splitter for transmitting light of the intermediate beam of that optical assembly to produce a transmitted beam of light, light of the transmitted beam of that optical assembly being reflectively modulated by the second modulator of that optical assembly and then being reflected by the polarization beam splitter to produce light constituting the further beam of that optical assembly.

37. An optical assembly comprising:
a source of a primary beam of linearly polarized light of a first linear polarization type;
a polarization beam splitter for reflecting light of the primary beam to produce a reflected beam of linearly polarized light of the first linear polarization type;
a first modulator for reflectively modulating light of the reflected beam to produce an initial modulated beam of linearly polarized light of a second linear polarization type opposite to the first linear polarization type, light of the initial modulated beam being transmitted through the polarization beam splitter to produce a first intermediate modulated beam of linearly polarized light of the second linear polarization type; and
a second modulator for reflectively modulating light of the first intermediate modulated beam to produce a second intermediate modulated beam of linearly polarized light of the first linear polarization type, light of the second intermediate modulated beam being reflected by the polarization beam splitter to produce a further modulated beam of linearly polarized light of the first linear polarization type.

38. An optical assembly as in claim 37 wherein each modulator comprises a light-reflective liquid-crystal display.

39. An optical assembly as in claim 37 wherein the polarization beam splitter reflects light of the primary beam and the second intermediate modulated beam by approximately 90° to respectively produce the reflected beam and the further modulated beam.

40. An optical assembly as in claim 37 further including a relay lens (a) for directing light of the first intermediate modulated beam to the second modulator and (b) for directing light of the second intermediate modulated beam to the polarization beam splitter.

41. An optical assembly comprising:
a source of a primary beam of linearly polarized light of a first linear polarization type;
a polarization beam splitter for transmitting light of the primary beam to produce a transmitted beam of linearly polarized light of the first linear polarization type;
a first modulator for reflectively modulating light of the transmitted beam to produce an initial modulated beam of linearly polarized light of a second linear polarization type opposite to the first linear polarization type, light of the initial modulated beam being reflected by the polarization beam splitter to produce a first intermediate modulated beam of linearly polarized light of the second linear polarization type; and
a second modulator for reflectively modulating light of the first intermediate modulated beam to produce a second intermediate modulated beam of linearly polarized light of the first linear polarization type, light of the second intermediate modulated beam being transmitted by the polarization beam splitter to produce a further modulated beam of linearly polarized light of the first linear polarization type.

42. An optical assembly as in claim 41 wherein each modulator comprises a light-reflective liquid-crystal display.

43. An optical assembly as in claim 41 wherein the polarization beam splitter reflects light of the initial modulated beam by approximately 90° to produce the first intermediate modulated beam.

44. An optical assembly as in claim 41 further including a relay lens (a) for directing light of the first intermediate modulated beam to the second modulator and (b) for directing light of the second intermediate modulated beam to the polarization beam splitter.

45. An optical assembly comprising:
a source of a primary beam of linearly polarized light of a first linear polarization type and of a selected color;
a first polarization beam splitter for reflecting light of the primary beam to produce a reflected beam of linearly polarized light of the first linear polarization type;
a first modulator for reflectively modulating light of the reflected beam to produce an initial modulated beam of linearly polarized light of a second linear polarization type opposite to the first linear polarization type, light of the initial modulated beam being transmitted by the first polarization beam splitter to produce a first intermediate modulated beam of linearly polarized light of the second linear polarization type;
a second polarization beam splitter for substantially solely transmitting light of the first intermediate beam to produce a second intermediate beam of linearly polarized light of the second linear polarization type;
a second modulator for substantially solely reflectively modulating light of the second intermediate modulated beam to produce a third intermediate modulated beam of linearly polarized light of the first linear polarization type, light of the third intermediate modulated beam being reflected by the second polarization beam splitter to produce a further modulated beam of linearly polarized light of the first linear polarization type.

46. An optical assembly as in claim 45 wherein each modulator comprises a light-reflective liquid-crystal display.

47. An optical assembly as in claim 45 wherein:
the first polarization beam splitter reflects light of the primary beam by approximately 90° to produce the reflected beam; and
the second polarization beam splitter reflects light of the third intermediate beam by approximately 90° to produce the further modulated beam.

48. An optical assembly as in claim 45 further including a relay lens for directing light of the first intermediate modulated beam to the second polarization beam splitter.

49. An optical assembly comprising:
a source of a primary beam of linearly polarized light of a first linear polarization type;
a first polarization beam splitter for transmitting light of the primary beam to produce a transmitted beam of linearly polarized light of the first linear polarization type;
a first modulator for reflectively modulating light of the transmitted beam to produce an initial modulated beam of linearly polarized light of a second linear polarization type opposite to the first linear polarization type, light of the initial modulated beam being reflected by the first polarization beam splitter to produce a first intermediate modulated beam of linearly polarized light of the second linear polarization type;
a second polarization beam splitter for reflecting light of the first intermediate beam to produce a second intermediate beam of linearly polarized light of the second linear polarization type; and
a second modulator for reflectively modulating light of the second intermediate modulated beam to produce a third intermediate modulated beam of linearly polarized light of the first linear polarization type, light of the third intermediate modulated beam being transmitted by the second polarization beam splitter to produce a further modulated beam of linearly polarized light of the first linear polarization type.

50. An optical assembly as in claim 49 wherein each modulator comprises a light-reflective liquid-crystal display.

51. An optical assembly as in claim 49 wherein:
the first polarization beam splitter reflects light of the initial modulated beam by approximately 90° to produce the first intermediate modulated beam; and
the second polarization beam splitter reflects light of the first intermediate beam by approximately 90° to produce the second intermediate modulated beam.

52. An optical assembly as in claim 49 further including a relay lens for directing light of the second intermediate modulated beam to the second polarization beam splitter.

53. An optical assembly comprising:
a source of a primary beam of linearly polarized light of a first linear polarization type or of a second linear polarization type opposite to the first linear polarization type;
a first modulator for transmissively modulating light of the primary beam to produce an initial modulated beam of linearly polarized light of the second linear polarization type;
a polarization beam splitter for reflecting light of the initial modulated beam to produce a first intermediate beam of linearly polarized light of the second linear polarization type; and
a second modulator for reflectively modulating light of the first intermediate modulated beam to produce a second intermediate modulated beam of linearly polarized light of the first linear polarization type, light of the second intermediate modulated beam being transmitted through the polarization beam splitter to produce a further modulated beam of linearly polarized light of the first linear polarization type.

54. An optical assembly as in claim 53 wherein:
the first modulator comprises a light-transmissive liquid-crystal display; and
the second modulator comprises a light-reflective liquid-crystal display.

55. An optical assembly as in claim 53 wherein the polarization beam splitter reflects light of the initial modulated beam by approximately 90° to produce the first intermediate beam.

56. An optical assembly as in claim 53 further including a relay lens for directing light of the initial modulated beam to the polarization beam splitter.

57. An optical assembly comprising:
a source of a primary beam of linearly polarized light of a first linear polarization type or of a second linear polarization type opposite to the first linear polarization type;
a first modulator for transmissively modulating light of the primary beam to produce an initial modulated beam of linearly polarized light of the second linear polarization type opposite to the first linear polarization type;
a polarization beam splitter for transmitting light of the initial modulated beam to produce a first intermediate beam of linearly polarized light of the first linear polarization type; and
a second modulator for reflectively modulating light of the first intermediate modulated beam to produce a second intermediate modulated beam of linearly polarized light of the second linear polarization type, light of the second intermediate modulated beam being reflected by the polarization beam splitter to produce a further modulated beam of linearly polarized light of the second linear polarization type.

58. An optical assembly as in claim 57 wherein:
the first modulator comprises a light-transmissive liquid-crystal display; and
the second modulator comprises a light-reflective liquid-crystal display.

59. An optical assembly as in claim 57 wherein the polarization beam splitter reflects light of the second modulated beam by approximately 90° to produce the further modulated beam.

60. An optical assembly as in claim 57 further including a relay lens for directing light of the initial modulated beam to the polarization beam splitter.

61. A light projection method comprising:
modulating light of a plurality of primary beams of linearly polarized light to respectively produce a like plurality of further beams of modulated light such that light of at least one, but not all, of the primary beams is sequentially modulated;
combining light of the further beams to produce a composite beam of light; and
projecting light of the composite beam.

62. A method as in claim 61 wherein the modulating act entails reflectively modulating the primary beams.

63. A method as in claim 61 wherein:
there are three primary beams; and
light of only one of the three primary beams is sequentially modulated.

64. A method as in claim 61 wherein:
the three primary beams are respectively constituted with red, blue, and green light; and
light of the primary beam of green light is sequentially modulated.

65. A method as in claim 61 wherein:
there are three primary beams; and
light of two of the three primary beams is sequentially modulated.

66. A method as in claim 61 wherein:
the three primary beams are respectively constituted with red, blue, and green light; and
light of each of the primary beams of green and red light is sequentially modulated.
